(19) United States
(12) Patent Application Publication
(10) Pub. No.: US 2026/0004766 A1
(43) Pub. Date: Jan. 1, 2026

(54) Method of Designing a Device Having a Plurality of Elements Using Phase Maps

(71) Applicant: UCL Business Ltd, London (GB)

(72) Inventors: James Hardwick, London (GB); Shubhi Bansal, London (GB); Christable Choi, London (GB); Sriram Subramanian, London (GB); Talamali Salah, London (GB); Panagiotis Florous, London (GB)

(21) Appl. No.: 18/992,677

(22) PCT Filed: Jul. 3, 2023
(86) PCT No.: PCT/GB2023/051740

§ 371 Date: Jan. 9, 2025

(30) Foreign Application Priority Data
Jul. 13, 2022 (GB) 2210285.9

(51) Int. Cl. G10K 11/28; G10K 11/30

(52) U.S. Cl. CPC G10K 11/28; G10K 11/30

(57) ABSTRACT

A method (100) of designing a segmented display device (1) having a plurality of elements (5) arranged in an array (3), each element (5) providing an individual output such that the plurality of elements (5) form a collective output of the device (1), wherein each element (5) is actuatable to control the individual output, the method (100) comprising: providing (102) a set (7) of images (9) representing a set of collective outputs from the device (1); generating (104) phase maps (13) of the images (9), the phase maps (13) having a phase value for each element (5) of the plurality of elements (5); and based on the phase maps (13), generating a plurality of non-overlapping groups of elements, wherein the elements (5) in each group are arranged to be actuated together as a segment (15) to cause display of any one of the set of collective output.

The present invention relates to display devices. In particular but not exclusively, the present invention relates to segmented display devices, and methods for segmenting the display device. The device may be a visual display device or an acoustic display device. The present invention also relates to dynamically controllable acoustic elements for acoustic display devices that can be used to switch between different outputs on an acoustic display device.

Various types of display devices are known. Visual display devices may be comprised of pixels formed of light emitting elements that are actuated to generate images. Acoustic display devices can emit or modulate sound in order to create sonic holograms. In some cases, they can be perceived as haptic sensations. Acoustic effects may also be used to generate visual displays by using acoustic levitation, or other similar effects, to actuate pixels.

For acoustic displays, Spatial Sound Modulators (SSMs) can be used. These are devices which shape incident sound fields using independent sound modulating units which can locally tune the phase and/or amplitude of sound waves. As such, each unit may be considered as a pixel of the acoustic display.

To accurately generate complex sound fields such as holographic images, SSMs must adhere to the Nyquist sampling rate. This means that the pitch between the sound modulating elements must be less than or equal to half the wavelength of the incident sound waves. For high frequency applications, building corresponding Nyquist-scaled SSMs with precisely fabricated elements at low mm and sub mm scales is extremely challenging. Moreover, when the required elements are smaller, more of them are needed to build a functional SSM.

Due to the control systems required, existing SSMs, such as phased-arrays of transducers (PATs) or motorised metasurfaces, are typically made of uniformly distributed, larger-than-wavelength elements. The presence of larger-than-wavelength elements leads to aliasing effects and thus inferior quality sound fields.

Segmented displays have long been a popular method for visual presentation of information and are commonly used to create a finite set of glyphs or characters. For example, a simple seven segment alphanumeric display is often used on the screens of calculators, parking meters, industrial equipment and many other devices. While segmented displays are widely used in visual data representation devices, they are far less common in acoustic displays.

For spatial light modulations, the generated patterns from separate pixels coincide directly. Therefore, segmented visual displays can be designed by simply shaping the segments to follow the same geometrical forms within the desired outputs. On the other hand, for acoustic display, the generated patterns are located at a distance from the sound modulating elements and linked by a complex propagation function. For this reason, designing segments in acoustic displays is less straightforward than their visual analogue.

Typically, designing segmented displays, and in particular, the process of grouping individual output elements into different segments has been carried out heuristically. This can be complex and computationally intensive for acoustic displays and complex visual displays, and in some cases may not produce a viable result.

There is therefore a need to provide a method of determining suitable segments for acoustic displays. Whilst segmentation of visual display can also be straightforward in some cases, it can still be complex for many situations. There is also, therefore, a desire to improve on the efficiency of generating segments for segmented visual displays, and to enable more complex outputs using segmented displays.

Designing segmented SSMs which can generate a finite set of acoustic images using fewer sound modulating elements appears equivalent to finding a sparse representation of the sound modulations necessary for generating the images. However, existing sparse representation techniques, which minimise the number of sound modulating elements for generating a merged version of all desired images, fall short in maintaining the ability to dynamically switch between different images in a finite set.

Acoustic metamaterials (AMMs) are an alternative candidate for use in acoustic displays. AMMs are artificially structured materials, which can bend and manipulate sound waves. Each AMM consists of unit elements, called meta-cells, which can be concatenated to create a 2D or 3D acoustic metasurface.

Most existing AMMs are passive, which means that they operate with a single structure design serving a particular functionality and cannot be tuned without manual intervention to reconfigure the structure for some other function. Recently, researchers have started looking into developing actively reconfigurable AMMs, which can be controlled during operation for a change in structure in real-time, thereby serving multiple functionalities. Currently, devices which allow dynamic switching between different outputs use integrated electric or magnetic actuation mechanisms for tuning and reconfiguring the structure. However, when operating in the ultrasonic regime (>20 kHz), the dimensions of AMMs become very small (1-10 mm) with subwavelength components, hence fabricating a tuneable structure becomes a challenge.

According to a first aspect of the invention, there is provided a method of designing a segmented display device having a plurality of elements arranged in an array, each element providing an individual output such that the plurality of elements form a collective output of the device, wherein each element is actuatable to control the individual output, the method comprising:
providing a set of images representing a set of collective outputs from the device;
generating phase maps of the images, the phase maps having a phase value for each element of the plurality of elements; and
based on the phase maps, generating a plurality of non-overlapping groups of elements, wherein the elements in each group are arranged to be actuated together as a segment to cause display of any one of the set of collective outputs.

Segmentation of a display simplifies the display device, meaning fewer actuators or output elements are required. This makes manufacture and operation of the display device simpler and more efficient.

For visual display devices using light emitting elements, the method allows the projection of complex outputs with higher resolution images than existing segmented displays, when using an equal or lower number of light modulating elements.

For an acoustic output device, the method leads to a segmented device of fewer elements than ideal Nyquist-scaled SSMs, by balancing the quality of the generated sound fields and the number of sound modulating elements. The method is applicable to acoustic output devices which generate acoustic holograms, and also to acoustic output devices which generate a visual output using effects acoustic levitation and the like. Designs developed by the method achieve higher resolution images than existing larger-than-wavelength SSMs when using an equal or lower number of sound modulating elements.

At least some of the plurality of non-overlapping groups may comprise elements that are spatially separate from each other, or spatially separated groups of elements, such that at least some of the non-overlapping groups are non-contiguous.

The plurality of non-overlapping groups may be non-homogenous in size and shape.

At least some of the plurality of non-overlapping groups may comprise: elements having equal individual outputs in each of the collective outputs. At least some of the plurality of non-overlapping groups may comprise: elements having different individual outputs, wherein a relative difference between the individual outputs may be the same in each of the collective outputs.

The output device may be a visual display comprising light emitting elements arranged to emit light, or elements actuated by acoustic levitation or other effects. Each element may correspond to a pixel with variable individual output.

The output device may be an acoustic device. The device may comprise an acoustic metamaterial arranged to modulate soundwaves as they are transmitted or reflected. Each element may be independently actuatable to vary the degree of modulation, to switch between different output images.

The step of generating the phase maps may comprise using a phase retrieval algorithm.

The phase retrieval algorithm may comprise the steps of:
backpropagating a representation of the target image from the target plane to a plane defined by the elements of the output device;
isolating and saving the phase over an area defined by the output device, and updating the signal by resetting the amplitudes to a reference value;
forward-propagating the updated signal from the plane defined by the elements of the output device to the target plane.

The method may comprise: iteratively repeating the steps of back propagating, isolating and forward propagating and on completion, setting the saved phases as the phase map for generating a plurality of non-overlapping groups of elements.

The data in the phase maps may be compressed into multiple levels, in order to create a cascade of coalition formation problems that are solved hierarchically.

Each element may be arranged to passively apply a phase modulation φ without any actuation. Actuation of the sound modulating element may apply a further phase modulation of δ, such that the total phase modulation is φ+δ.

The output device may be able to dynamically switch between the different collective outputs.

The individual outputs of each element may be switchable between a pair of binary outputs, over a continuous range, or between a number of discrete outputs.

According to a second aspect of the invention, there is provided an output device comprising a segmented display, the device designed by the method of the first aspect.

According to a third aspect of the invention, there is provided an acoustic device comprising: a plurality of elements arranged in an array, each element arranged to transmit or reflect an incoming sound wave and modulate the incoming sound wave; and a control mechanism arranged to control the modulation applied by each element, wherein the plurality of elements are arranged in a plurality of non-overlapping groups, and each group is actuated together as a single segment in the output device.

By operating the output elements in groups, the manufacture and operation of the device is simple and efficient since fewer actuators or output elements are required.

The device balances the quality of the generated sound fields and the number of sound modulating elements, and can provide higher resolution images than existing larger-than-wavelength SSMs when using an equal or lower number of sound modulating elements.

At least some of the plurality of non-overlapping groups may comprise elements that are spatially separate from each other, or spatially separated groups of elements, such that at least some of the non-overlapping groups are non-contiguous. The plurality of non-overlapping groups may be non-homogenous in size and shape.

At least some of the plurality of non-overlapping groups may comprise: elements having equal individual outputs in each of the collective outputs. At least some of the plurality of non-overlapping groups may comprise: elements having different individual output, wherein a relative difference between the individual outputs may be the same in each of the collective outputs.

The output device may be able to dynamically switch between the different collective outputs.

The individual outputs of each element may be switchable between a pair of binary outputs, over a continuous range, or over a number of discrete outputs.

The acoustic device of the third aspect may be designed by the method of the first aspect. In particular, the method of the first aspect may be used to determine the grouping of the sound modulating elements of the acoustic device.

According to a fourth aspect of the invention, there is provided an acoustic element arranged to reflect sound and modulate the sound as it is reflected, the element comprising: a fluid channel having an open end; a membrane over the open end of the fluid channel; and a reflector comprising a reflecting surface and an opposing engagement surface engaging the membrane, wherein changing a pressure or volume of fluid in the fluid channel inflates or deflates the membrane and moves the reflection surface, varying the modulation of sound applied by the element.

The element is simple to manufacture and easily scalable. By using fluid pressure to vary the output of the device, the output can be changed and does not require any ongoing input to be held at the set position. By using a membrane, the chance of leakage is reduced or eliminated, and the use of fluid pressure (without electrodes) means there is no corrosion. Furthermore, the reflecting surface can be moved over a range of positions, rather than simple binary positions, providing a range of variation the modulation. The acoustic element requires low power or voltage for actuation, does not require magnetic shielding, and can be made outside of a cleanroom (which makes it cost-effective).

The open end of the fluid channel may be formed as an aperture in a planar surface. A rim may be provided around the opening. The reflecting surface of the reflector may extend parallel to the planar surface. Moving the reflection surface may vary the distance between the planar surface and the reflection surface, keeping the reflecting surface parallel to the planar surface.

The acoustic element may comprise a guide member, the reflector slidably engaging the guide member to constrain movement of the reflector along an axial direction.

The reflector may be formed by a head portion forming the reflecting surface and tail portion engaging the membrane.

The guide may guide the tail portion. The guide may be formed as a tubular member extending from the planar surface around the opening. The tail portion may be received within the guide.

The guide may include a stop to limit the movement of the reflector.

The control mechanism may control the volume of fluid in the channel to inflate and deflate the membrane.

According to a fifth aspect of the invention, there is provided an acoustic device comprising: a microfluidic chip and a plurality of acoustic elements according to the fourth aspect, wherein the acoustic elements are arranged into a plurality of non-overlapping groups; and for each group, a supply channel formed in the microfluidic chip, the fluid channel coupled to the fluid channel of each of the acoustic elements in the group.

Each group may have a single reflector. The head portion may comprise a plurality of reflecting surfaces. The reflector may comprise one or more tail portions, each slidably located with respect to the guide.

The openings for the acoustic elements may be formed as an array in a front face of the microfluidic chip. A rim may be formed around the array to locate the reflectors. The rim may locate the guides. The guides for the separate tail portions may be integrated into a single frame.

The groups of acoustic elements may be determined by the method of the first aspect. The acoustic device may form the device of the second or third aspect.

According to a sixth aspect of the invention, there is provided a method of manufacturing the acoustic device of the fifth aspect, the method comprising:
making a microfluidic chip defining the channels;
making the membrane;
securing the membrane to a front face of the microfluidic chip to seal openings in the front face of the chip;
making a frame and reflectors received in the frame, and securing the frame to the microfluidic chip.

The chip may comprise multiple layers to define the channels. The channel may extend through a plurality of layers separated by interconnecting layers. The interconnecting layers may define straight through passages between layers incorporating portions lateral portions of the channels. The through passage of an interconnecting layer may be positioned at an end point of channel portions in a channel portion layer below the interconnecting layer.

The through passage of an interconnecting layer may be positioned at a central point of the channel portions in a channel portion layer to which fluid flows towards, the central point equidistant to the end points of the channel portions in the channel portion layer to which fluid flows towards. For a segment or group of sound modulating elements, the outlets in the front face may be grouped into sub-segments. The first channel portion layer directly below the front face may connect openings in a sub-segment. First channel portions in a first channel portion layer may be grouped together into one or more groups. Second channel portions in a second channel portion layer may connect the first channel portions, the second channel portion layer being the next channel portion layer in the direction of fluid flow.

Making the membrane may comprise: forming the membrane on a non-stick surface; applying pressure to the membrane; and removing the membrane from the from the non-stick surface. Pressure may be applied by pressing down on the membrane via a second non-stick surface. The non-stick surface(s) may be a planar area coated with soap. The method may comprise providing a spacer between the non-stick surfaces to control the thickness of the membrane.

According to a seventh aspect of the invention, there is provided an acoustic element arranged to transmit sound and modulate the sound as it is transmitted, the element comprising: a wall enclosing a channel defining a transmission path for sound, the transmission path having a path length; and a flap having a first end pivotally connected to the wall inside the channel and an opposing second end free within the channel; wherein pivotal movement of the flap around the first end varies the path length of sound passing though the channel, modulating the sound.

The element is simple to manufacture and easily scalable. Actuation using an external magnetic field provides reliable operation, allowing remote actuation with the absence of bulky circuitry. Furthermore, the reflecting surface can be moved over a range of positions, rather than simple binary positions, providing a range of variation the modulation.

The flap may comprise a magnetic material. A magnetic field may be applied to cause pivotal movement of the flap.

The acoustic element may comprise a slidable insert received in the channel, the slidable insert forming the portion of the wall to which the flap is pivotally connected, the flap formed as part of the insert.

The channel may comprise a fixed flap arranged to control the path length of sound passing through the channel.

According to an eighth aspect of the invention, there is provided an acoustic device comprising: a plurality of parallel channels, each channel arranged as an acoustic element according to the seventh aspect, the acoustic elements arranged into a plurality of non-overlapping groups; and for each group, a magnetic field generator arranged to actuate movement of the flaps.

The groups of acoustic elements may be determined by the method of the first aspect. The acoustic device may form the device of the second or third aspect.

According to a ninth aspect of the invention, there is provided a method of manufacturing the device of the eighth aspect, the method comprising:
making a body defining one or more parallel channels;
making one or more flaps to be pivotally connected inside the channels;
fixing each flap to a separate insert arranged to be received in one of the channels of the body; and
sliding each insert into a corresponding channel.

The flap may be made by dispensing a liquid into a mould defining the shape of the flap; removing the flap from the mould and fixing the flap to the insert. Making the flap may include applying pressure to the flap whilst curing the flap. Pressure may be applied through a surface secured on top of the mould. The mould may be made of non-stick material.

According to a tenth aspect, there is provided a method of manufacturing a microfluidic chip comprising a plurality of channels extending between one or more inlets and one or more outlets, such that each inlet may be coupled to one or more outlets, and each outlet is connected to one inlet only. The chip may comprise multiple layers through which the channels extend. The method may comprise: providing a plurality of layers and forming channels extending through the layers.

According to an eleventh aspect, there is provided a microfluidic chip, comprising a plurality of channels extending between one or more inlets and one or more outlets, such that each inlet may be coupled to one or more outlets, and each outlet is connected to one inlet only. The microfluidic chip may comprise multiple layers through which the channels extend. Preferably the microfluidic chip is made according to the method of the tenth aspect.

The microfluidic chip may comprise channel portion layers incorporating laterally extending portions of the channels. Interconnecting layers may define straight through passages between channel portion layers.

The through passage of an interconnecting layer may be positioned at an end point of channel portions in a channel portion layer from which fluid flows into the interconnecting layer. The through passage of an interconnecting layer may be positioned at a central point of channel portions in a channel portion layer to which fluid flows into from the interconnecting layer, the central point equidistant to the end points of the channel portions in the channel portion layer to which fluid flows into.

Outlets in the front face of the microfluidic chip may be arranged to form sound modulating elements. The sound modulating elements may be arranged in groups or segments. The groups or segments of sound modulating elements may be comprise elements that are spatially separate from each other, or spatially separated groups of elements. The groups may be non-homogenous in size and shape.

The outlets corresponding to sound modulating elements in a segment or group may be organised into sub-segments. First channel portions in a first channel portion layer directly below the front face may connect openings in a sub-segment. The first channel portions in the first channel portion layer may be organised into one or more groups. Second channel portions in a second channel portion layer may connect the first channel portions, the second channel portion layer being the next channel portion layer in the direction of fluid flow.

According to a twelfth aspect of the invention, there is provided a method of manufacturing a membrane, the method comprising: forming the membrane on a non-stick surface; applying pressure to the membrane; and removing the membrane from the from the non-stick surface.

Pressure may be applied by pressing down on the membrane with a second non-stick surface. The non-stick surface may be a planar area coated with soap. The method may comprise providing a spacer between the non-stick surfaces to control the thickness of the membrane.

According to a thirteenth aspect of the invention, there is provided a membrane made according to the twelfth aspect.

It will be appreciated that, unless mutually exclusive, any feature described with respect to one of the above aspects may be applied mutatis mutandis to any other aspect.

Embodiments of the invention will now be described, by way of example only, with reference to the accompanying drawings, in which:

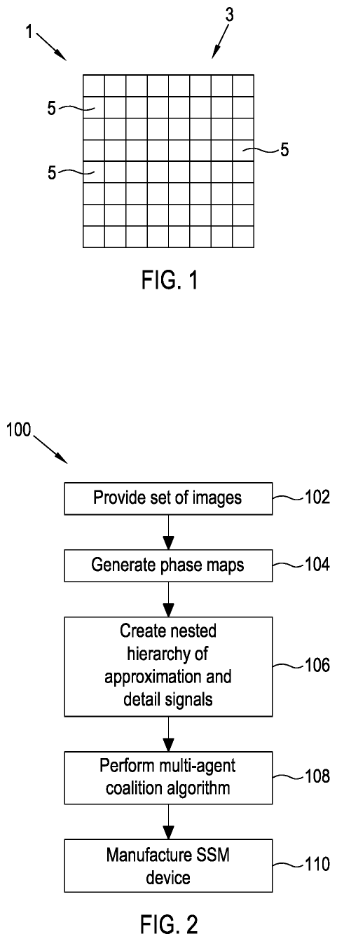

FIG. 1 schematically illustrates an array of sound modulating elements forming a spatial sound modulating device;

FIG. 2 illustrates a flow chart of a method for designing a sound modulating device arranged to output a finite set of target acoustic images;

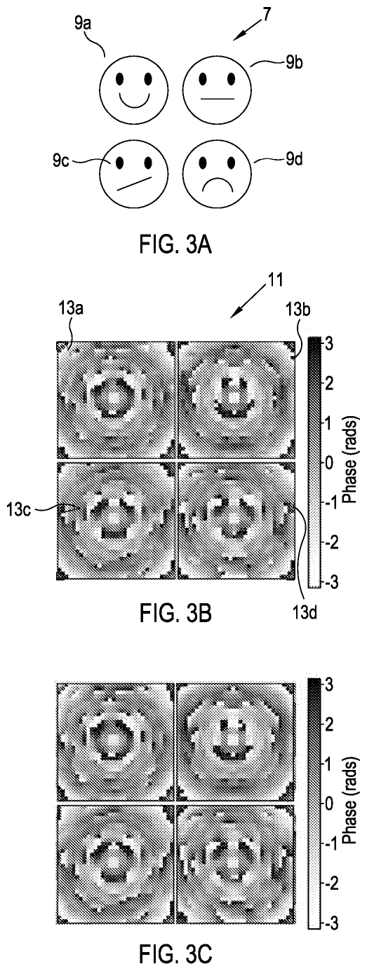

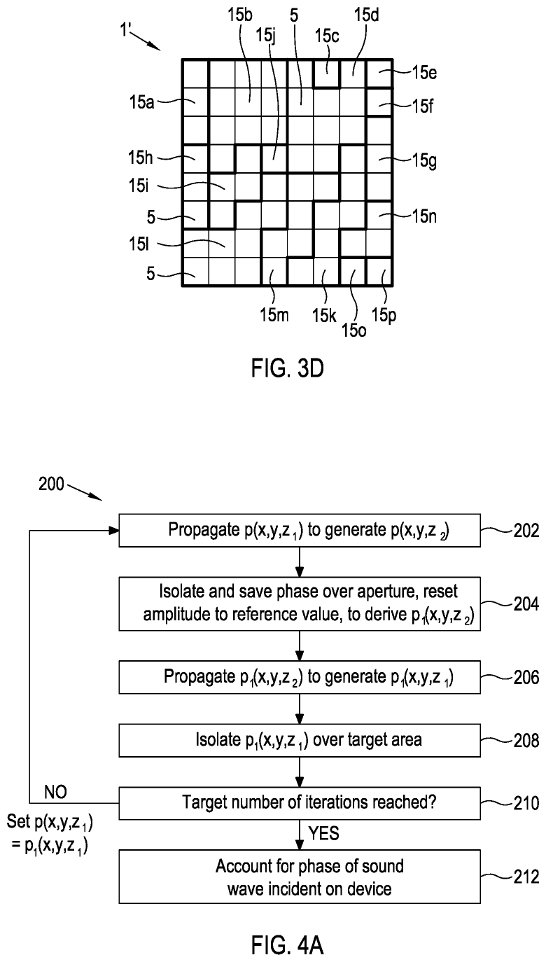

FIG. 3A illustrate a set of target acoustic images for use in the method of FIG. 2;

FIG. 3B illustrates phase maps generated from the target images of FIG. 3A;

FIG. 3C illustrates an optimised segmented phase maps, generated in the method of FIG. 2, using the phase maps of FIG. 3A;

FIG. 3D schematically illustrates a segmented sound modulating device based on the optimised segmented phase maps of FIG. 3C;

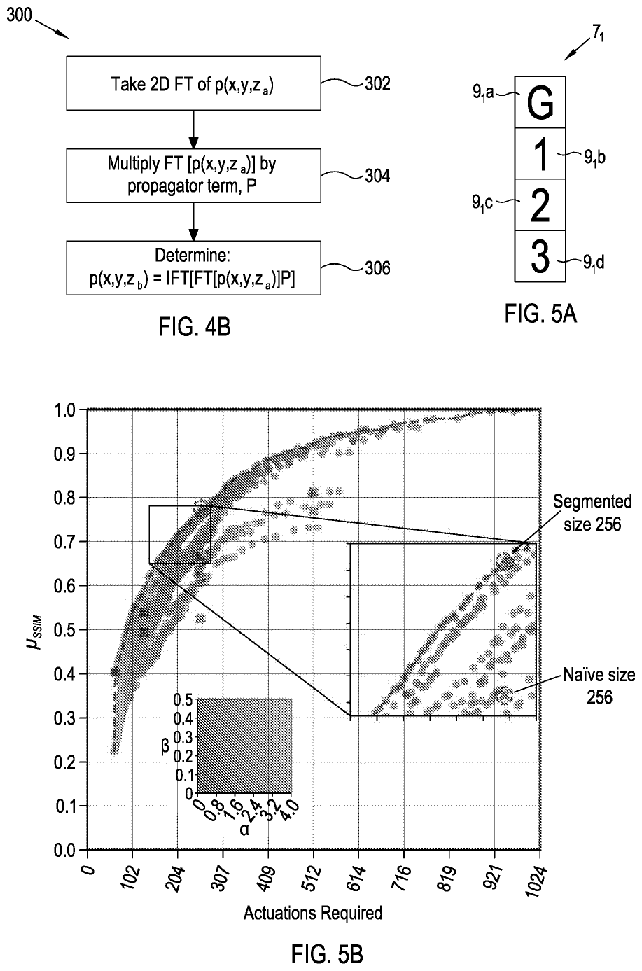

FIG. 4A illustrates the step of generating the phase maps in the method of FIG. 2, in more detail;

FIG. 4B illustrates the method of propagating complex signals between two planes, from the method of FIG. 4A;

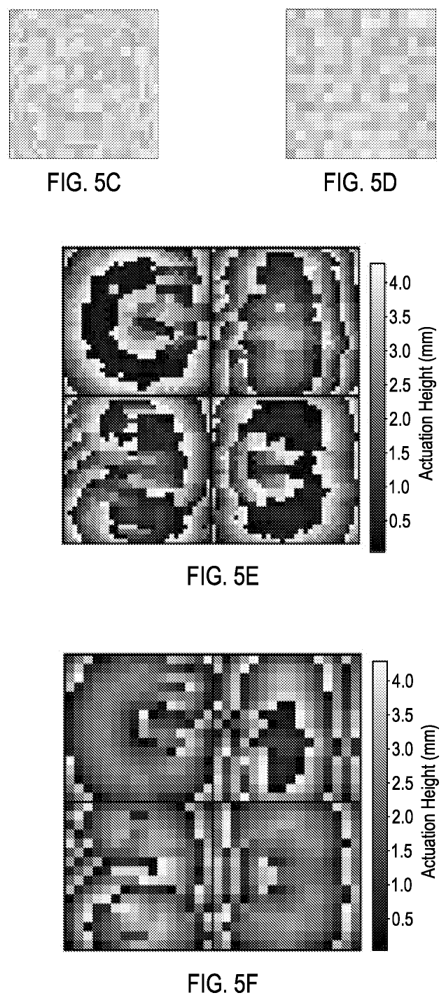

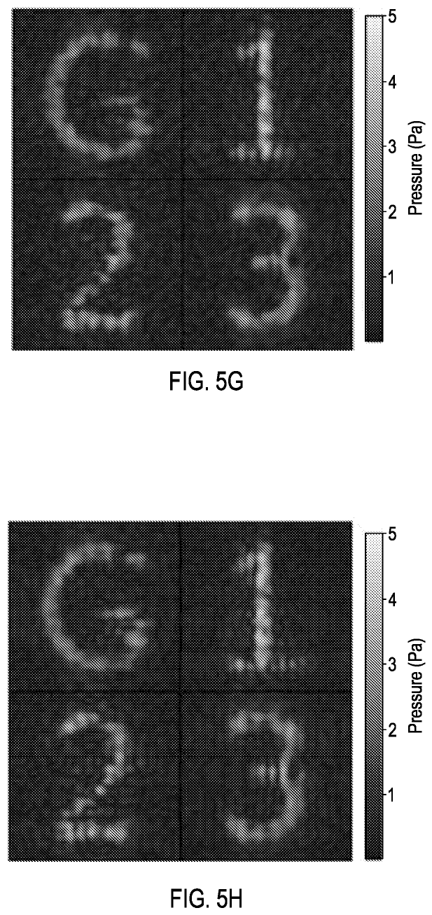

FIG. 5A shows an example set of target images;

FIG. 5B shows the Pareto Front sweep for a spatial sound modulating device designed to form the target images of FIG. 5A;

FIGS. 5C and 5D schematically illustrates the segments of a spatial sound modulating device for projecting the target images of FIG. 5A, derived by the method of FIG. 2 and a naïve segmentation algorithm respectively;

FIGS. 5E and 5F show the actuation heights of reflective sound modulation elements required to achieve the target images of FIG. 5A for the segments derived by the method of FIG. 2 and a naïve segmentation algorithm respectively;

FIGS. 5G and 5H show the absolute pressure propagations derived from the reflections generated by the reflective sound modulation elements shown in FIGS. 5E and 5F respectively;

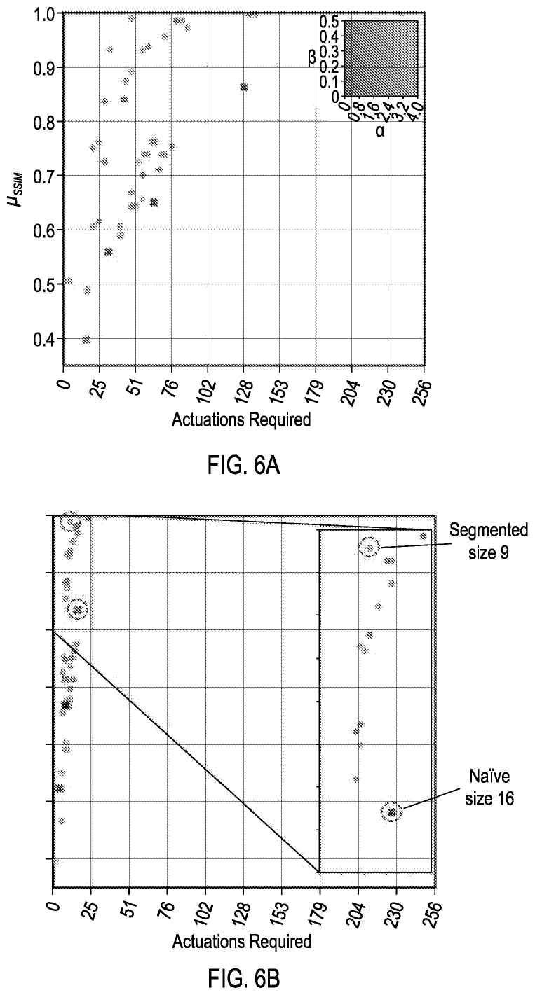

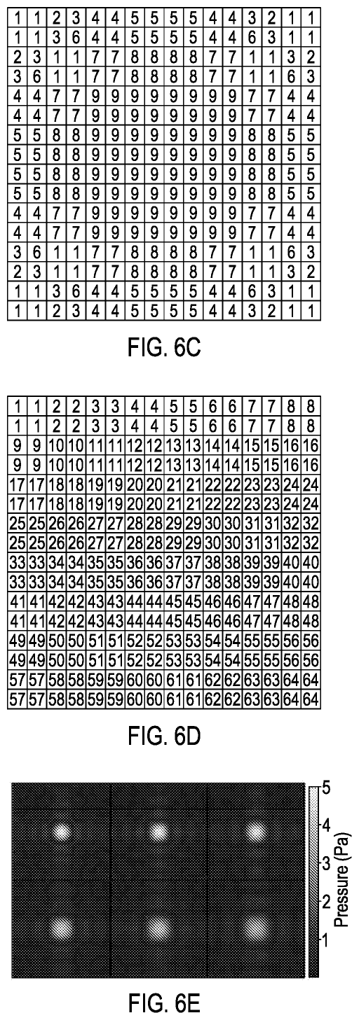

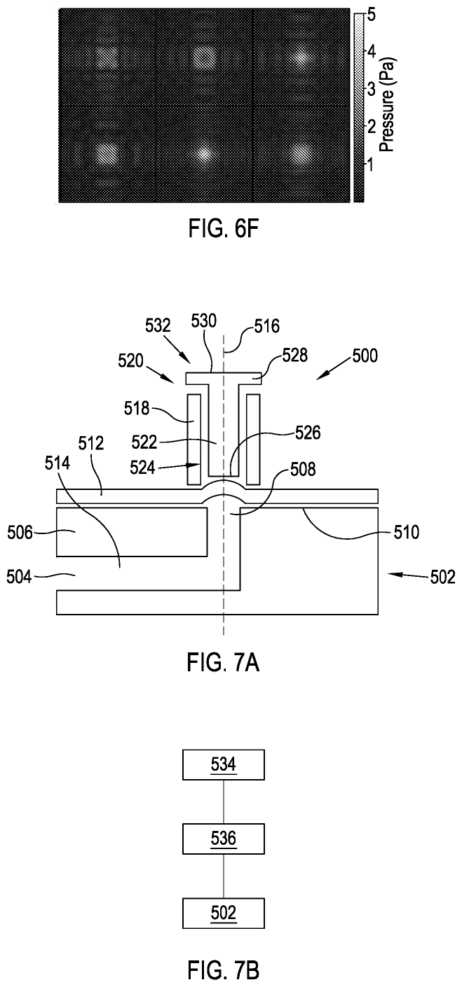

FIG. 6A shows the Pareto Front sweep for a spatial sound modulating device designed to act as an acoustic lens;

FIG. 6B shows the Pareto Front sweep of FIG. 6A after symmetry of dots focused by an acoustic lens is taken into account;

FIGS. 6C and 6D show a spatial sound modulating device for acting as an acoustic lens, derived by the method of FIG. 2 and a naïve segmentation algorithm respectively;

FIGS. 6E and 6F show the absolute pressure propagations derived from the reflections generated by the devices segmented as shown in FIGS. 5E and 5F respectively;

FIGS. 7A and 7B schematically illustrate an example of a reflective sound modulating element;

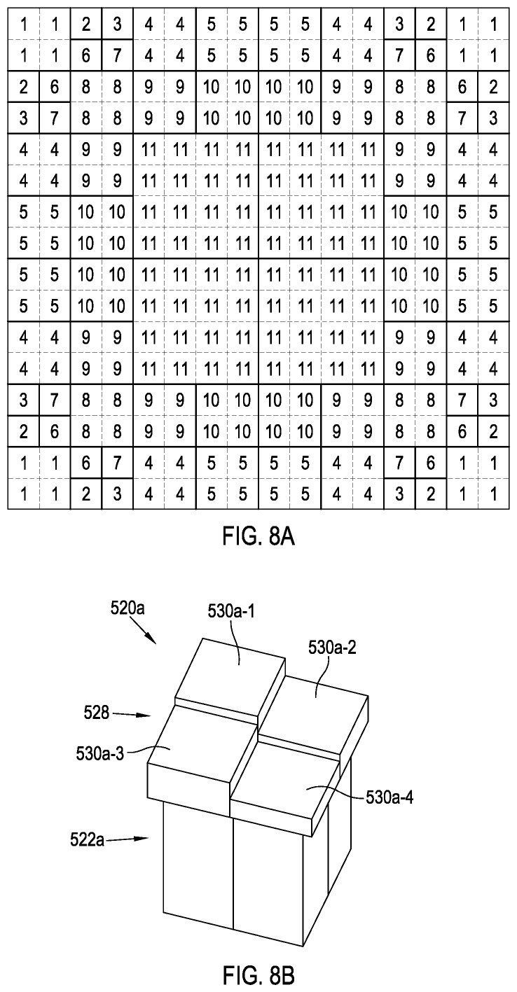

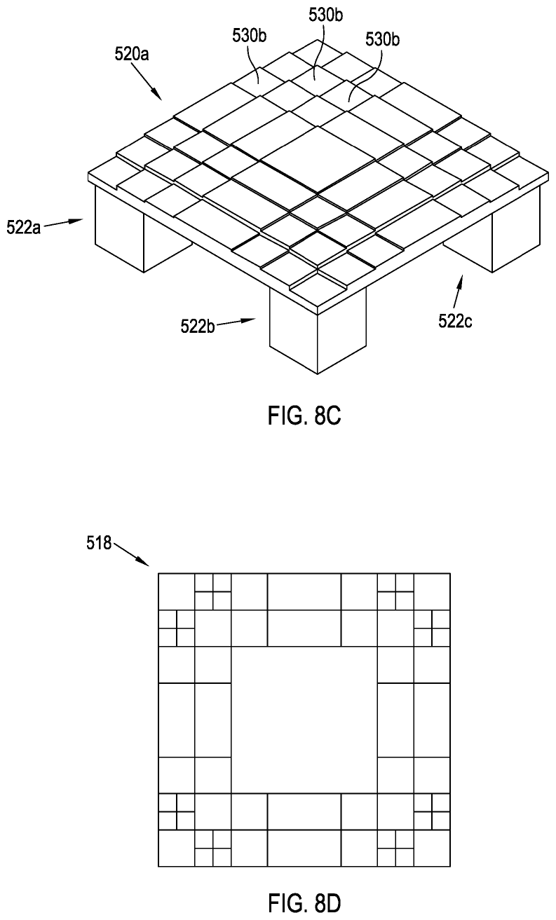

FIG. 8A illustrates a spatial sound modulating device made using an array of the elements shown in FIGS. 7A and 7B, arranged into segments;

FIG. 8B shows an example of a reflector for a first of the segments in the device of FIG. 8A;

FIG. 8C shows an example of a reflector for a second of the segments in the device of FIG. 8A;

FIG. 8D shows an example frame for the device of FIG. 8A;

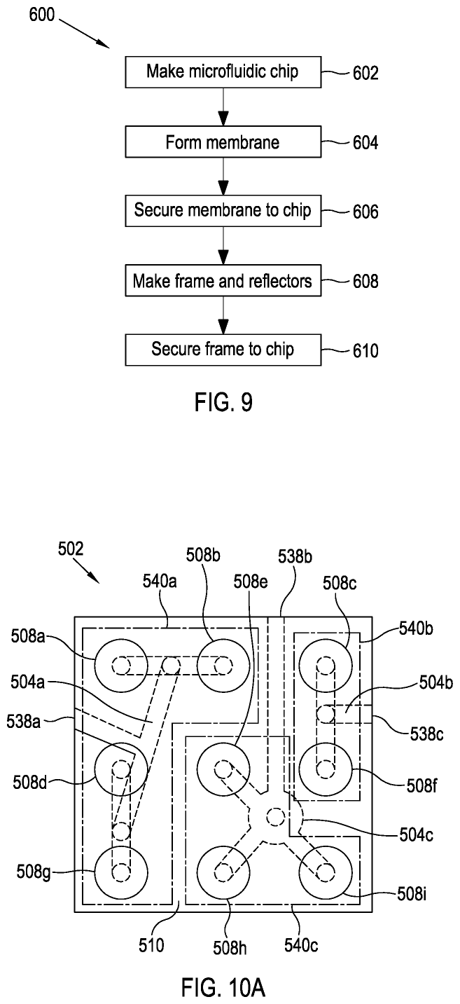

FIG. 9 illustrates a flow chart showing a method for forming a device made using an array of the elements shown in FIGS. 7A and 7B;

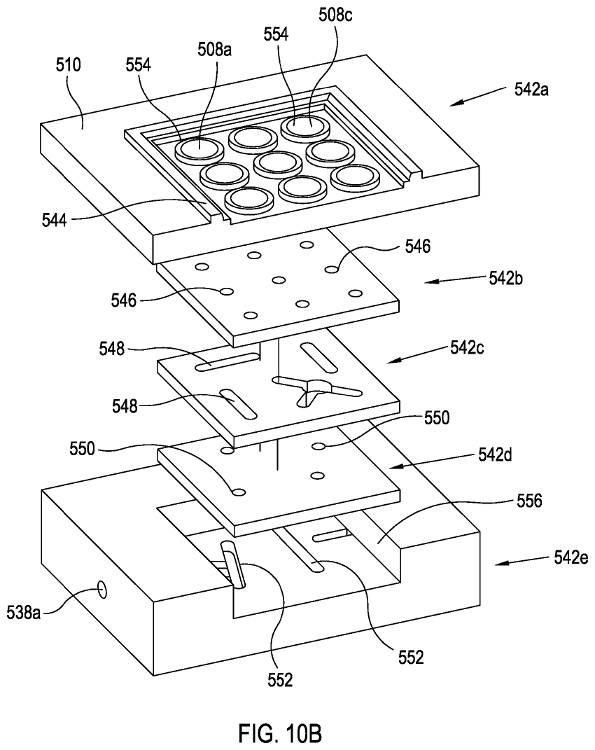

FIGS. 10A and 10B show a microfluidic chip forming part of a device made using an array of the elements shown in FIGS. 7A and 7B;

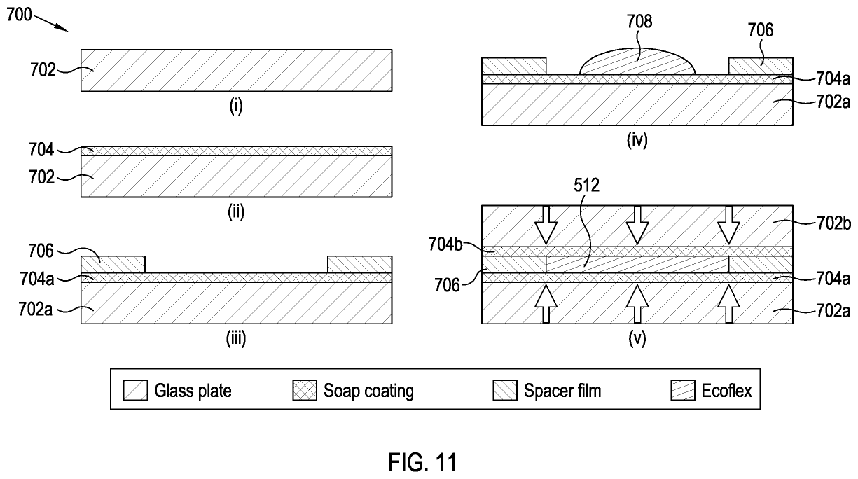

FIG. 11 schematically illustrate the steps for forming the membrane required for the method of FIG. 9;

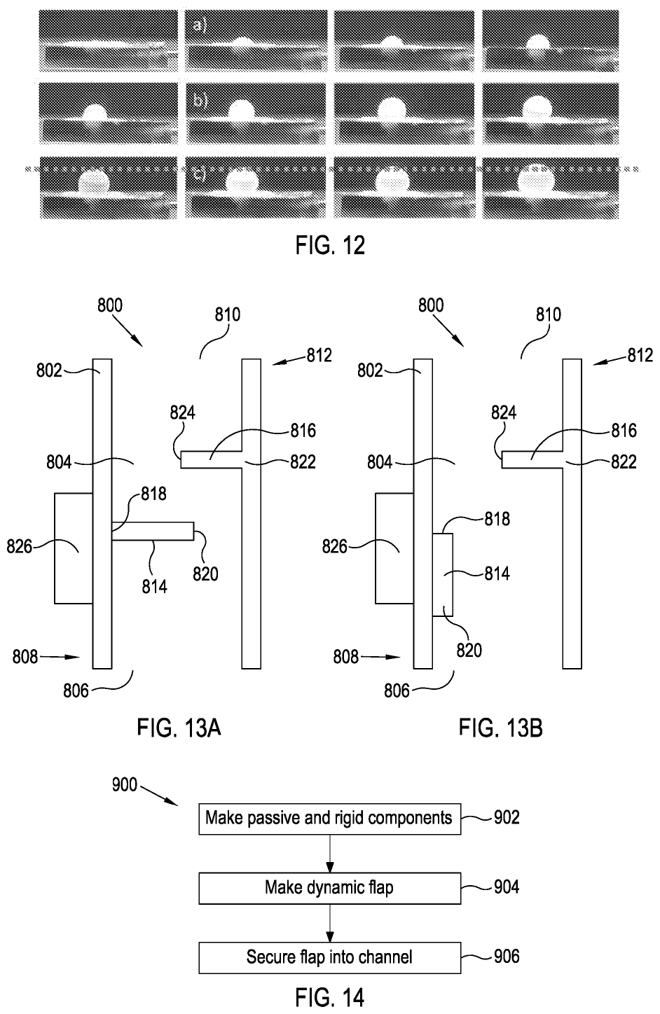

FIG. 12 shows images of inflation of a membrane made according to FIG. 11 fixed on a chip made as shown in FIGS. 10A and 10B;

FIGS. 13A and 13B schematically illustrate an example of a transmissive sound modulating element

FIG. 14 illustrates a flow chart showing a method for forming a device made using an array of the elements shown in FIGS. 13A and 13B;

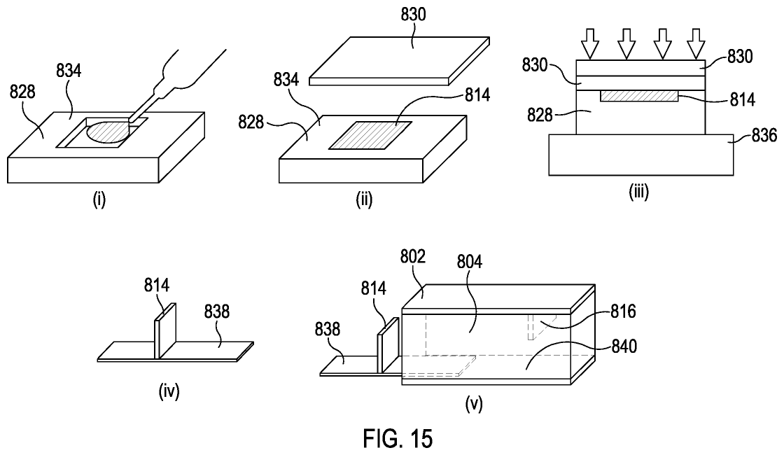

FIG. 15 schematically illustrate the steps for forming the insert for making a device made using an array of the elements shown in FIGS. 13A and 13B; and

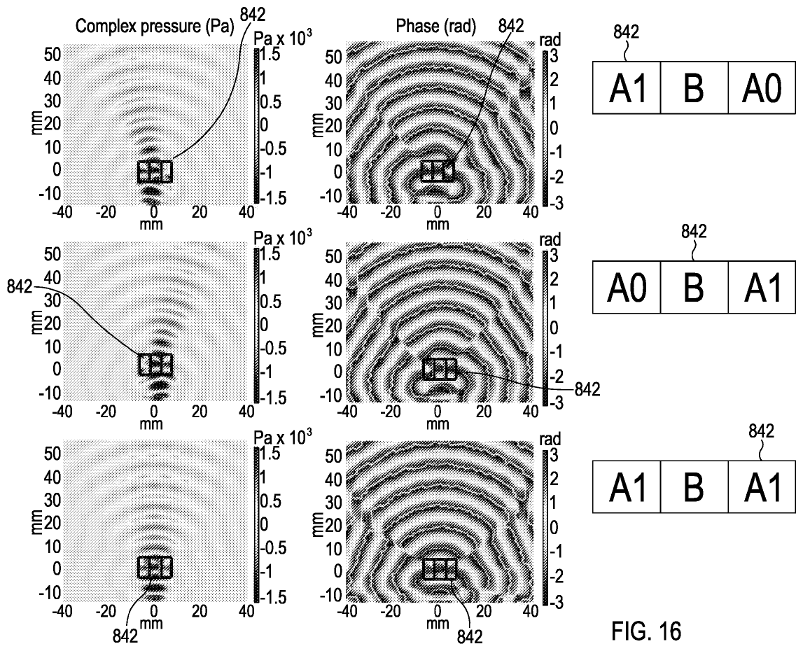

FIG. 16 shows the modelled complex pressure derived from a device having a 3 by 1 array of the elements shown in FIGS. 13A and 13B.

FIG. 1 illustrates a schematic example of an SSM output device 1. In the example shown, the output device is comprised of an 8×8 array 3 of sound modulating elements 5. The sound modulating elements 5 can either transmit or reflect sound from a source (not shown) and apply modulation to the sound as it is transmitted or reflected. By varying the modulation applied by each sound modulating element 5, a sonic hologram or images can be formed as a collective output, which a user perceives as a haptic effect at a distance from the SSM output device 1.

The SSM output device 1 may be used to provide a variety of output images, such as Braille symbols, alphanumeric symbols or any other desired output. The device 1 can dynamically switch between a predefined setoff outputs. In other words, the output from the SSM output device 1 can be switched in real-time to change between the different possible outputs.

In order to simplify the design, manufacture and operation of an SSM output device 1, the sound modulating elements 5 can be grouped into a plurality of different groups, as will be discussed below. Each group of sound modulating elements 5 is operated together as a single segment of the SSM output device 1. Therefore, a single switching signal can be sent to a group/segment, rather than controlling each sound modulating element 5 in the segment individually.

FIG. 2 shows a flow chart illustrating a method 100 of designing the SSM output device 1. In particular, the method 100 of FIG. 2 is used to determine the grouping of the sound modulating elements 5 into segments (also referred to as coalitions).

Many forms of coalition formation algorithm can be used. These generally fall into two broad categories; “full-search” algorithms which will return the absolute optimal structure of coalitions of sound modulating elements 5 for a given set of target images 9, and “good-enough” algorithms, which will return sub-optimal coalitions, but for a fraction of the computing cost. It will be appreciated that for a display device 1 having a large number of sound modulating elements, full-search algorithms may be computational expensive, and so it may be impossible or impractical to use such algorithms.

For a full search algorithm, the number of possible coalitions, nₚ which are searched in order to determine the optimal structure can be given as:

$${n}_{p} = {\sum }_{i = a}^{m} ( \begin{matrix}m \\ a\end{matrix} )$$

m is the maximum coalition size (the maximum number of sound modulating elements 5 in a segment 15) and a steps through all possible coalition sizes (i.e. the number of constituent pixels or sound modulating elements 5 in each segment) For example, when there are 16 sound modulating elements 5 (also referred to as agents) in the device 1, the algorithm will have 65535 potential coalitions with which to construct potential coalition structures, whereas if the number of agents is increased to 32 there are now 4.29×10⁹ potential coalitions. This exponential increase in the number of calculations means that a full search is only appropriate when the number of sound modulating elements 5 is relatively low, or if certain restrictions can be applied which reduce the total number of potential coalitions in the problem, and thus reduces the overall search space. This may include, for example, limiting a maximum coalition size or making an initial naïve segmentation.

In one example coalition formation algorithm, discussed below, a form of initial naïve segmentation operation is used to break the array 3 of sound modulating elements containing many agents (sound modulating elements 5) into a group of soluble smaller problems. This is coupled with a 2D wavelet decomposition, which compresses and solve multiple segmentations, expanding from a high state of compression and continually updating the coalition structure as it return to the original uncompressed image size.

The process is a multi-agent coalition formation technique which operates on the approximate representation of phase-maps, which are discrete distributions of phase modulations over a plane, at each level of a wavelet decomposition. The detail signals are then analysed, as components of the wavelet transform operation, to refine the coalitions and propagate the results to the next level, thereby creating a cascade of coalition formation problems and hierarchically constructing a segmented SSM device 1.

At a first step 102, a set 7 of the desired (or target) holographic images 9a-d. An example set 7 is shown in FIG. 3A. The set 7 is the set of outputs the SSM output device 1 under design will dynamically generate and switch between, in use. In the example shown, four simple emojis 9a-9d are provided, but this is by way of example only, and any suitable set 7 of desired holographic images 9 may be used having any number of desired outputs.

Any suitable method may be used for generating the desired holographic images. By way of example only, the images in FIG. 3A are generated by taking a glyph, font type and font size as inputs and converting these to normalised arrays between 1 and 0 in magnitude. In some examples, the number of elements in the array, and the size of the area represented by each element in the array corresponds to the individual elements 5 in the SSM display device 1, however, this need not be the case.

The normalised arrays are ideal absolute pressure maps which it is desired to generate at a target plane a certain distance from the acoustic device 1.

At a second step 104, a phase retrieval algorithm is used to generate a set 11 of phase maps 13 corresponding to the desired holographic images 9a-d.

The desired holographic images 9a-9d represent the idealised and normalised absolute pressure maps at the target plane. The phase maps 13, on the other hand, represent the relative phase over the imaging area at the plane of the array 3 of sound modulating elements 5.

FIG. 3B shows the phase maps 13a-d generated based on the desired holographic images 9a-d shown in FIG. 3A. The phase maps shown in FIG. 3B are generated using a process based on the Gerchberg-Saxton phase retrieval method discussed in R. W. Gerchberg W. O. Saxton. A practical algorithm for the determination of the phase from image and diffraction plane pictures. Optik (Stuttg). 35, 237-246 (1972).

FIGS. 4A and 4B illustrate an example of a method 200 for determining the phase map 13 of a target image 9.

In order to determine the phase map 13, the pressure values are propagated back and forth between the target plane z₁ and the plane of the array 3 of sound modulating elements 5 z₂. This is done using the angular spectrum method (ASM). Using ASM allows the propagation of a known 2D complex pressure field p(x,y,zₐ) from a plane zₐ, to a parallel plane z_{b}, at some given distance, returning the complex pressure field p(x,y,z_{b}), at this plane. FIG. 4B illustrates the ASM method 300.

At a first step 302 of the ASM process, the 2D fast Fourier transform (2D-FFT) of p(x,y,zₐ) is taken, decomposing the field into its “angular spectrum”—the group of component plane waves which describe the field in the reciprocal (Fourier) space.

At the second step 304, the Fourier transformed field is multiplied by a “propagator” term, P which describes how the phase of the field will evolve as it travels from zₐ to z_{b}. In one example, P is given by:

$$P = exp ( i \sqrt{{k}^{2} - {k}_{x}^{2} - {k}_{y}^{2}} ( {z}_{b} - {z}_{a} )$$

Returning to the method of FIG. 4, in a third step 206, the newly propagated 2D complex pressure field is inverse fast Fourier transformed (2D-IFFT) to return it from reciprocal space to real space and give p(x,y,z_{b}).

In a first step 202 of the method 200 used to find the phase-map 13 for a target image 9, the complex pressure field (p(x,y,z₂)) at the plane of the array 3 of sound modulating elements 5 is found using ASM and the complex pressure field (p(x,y,z₁)) at the target plane. The complex field at the target plane (p(x,y,z₁)) is taken directly from the values in the normalised array representing the target image 9.

At a next step 204, the backpropagated pressure is isolated over the area covered by the array 3 of sound modulating elements 5 on plane z₂, referred to as the aperture. The phase over the aperture is saved and the amplitude values are reset to a reference value determined by the acoustic wave source. This generates a new complex pressure field p₁(x,y,z₂).

At a third step 206, the new complex pressure field p₁(x,y,z₂) is propagated back to the target plane using ASM, to generate a new complex pressure field p₁(x,y,z₁)

At a subsequent step 208, the complex acoustic pressure p₁(x,y,z₁) is isolated over the target area in plane z₁ by overlaying the target image onto this pressure distribution and resetting the values outside this area to zero (for example by multiplying by zero.

The method is controlled to proceed for a predefined number of iterations. At step 210, a check is carried out to see if the predefined number of iterations have been completed. If the number of iterations is not reached, the process from steps 202 to 208 is repeated using the updated complex field at the target plane as the new target image. If the number if iterations is reached, the process proceed to step 212.

The predefined number of iterations may be determined based on known data showing when the algorithm typically tends to stability in the difference between the original target image 9 and the image propagated back to the target plane z₁. In other examples, the check step 210 may check for other criteria in addition to or as well as the number of iterations, for example, a threshold similarity between the original target image 9 and the image propagated back to the target plane z or other suitable criteria.

At step 212 the phase of the source waves incident on the array 3 of sound modulating elements 5 is taken into account such that the phase map 13 shows the phase change that needs to be applied by each sound modulating element 5 to generate the target image 9.

The process 200 of FIG. 4A is repeated for each target image 9a-d, to generate a corresponding phase map 13a-d.

The process discussed above is a modified version of the Gerchberg-Saxton algorithm called the iterative angular spectrum approach (IASA). However, this is given by way of example only, and any suitable phase retrieval method that provides the phase change that needs to be applied to incident sound from the source by each sound modulating element 5 may be used to generate the phase maps 13a-13d.

Returning to FIG. 2, at a next step 106, the phase-maps 13a-d are transformed using a 2D-wavelet decomposition to create a nested hierarchy of approximation and detail signals. The decomposition is limited to the approximate signals at each level, while preserving the three detail signals for further analysis. In one example, a 2D Haar wavelet decomposition is used.

Where the original phase-map is of size 2j×2j, the signal is decomposed into j levels, halving the size at each step in both dimensions, with level jₘₐₓ being the maximum degree of compression—a 1×1 matrix. At every intervening level k between level jₘₐₓ and 0, the 2D-wavelet decomposition results in one approximate and three detail maps each of dimension 2j−k×2j−k.

More generally, for a set of target images Tₖ, k∈{1, . . . , |T|}, each initial phase map 13a-d may be represented by an n×m matrix Aₖ. Each element/pixel in the matrix A(i,j) corresponds to the phase modulation of the sound modulating element at position (i,j) in an n×m array of sound modulating elements 5, where i∈{1, . . . , n} and j∈{1, . . . , m}.

A multi-level decomposition of the phase distributions Aₖ is performed using discrete wavelet transforms:

$$[ \begin{matrix}{A}_{k}^{l} & {H}_{k}^{l} \\ {V}_{k}^{l} & {D}_{k}^{l}\end{matrix} ] = W ( {A}_{k}^{l - 1} ) , l ∈ \{ l , … , {l}_{max} \} , {A}_{k}^{0} = {A}_{i} , k ∈ 1 , … , \vert T \vert$$

$${A}_{k}^{l}$$

is an approximation of the initial phase distribution

$${A}_{k}^{0}$$

at the l^{th} decomposition level.

$${H}_{k}^{l} , {V}_{k}^{l} , and {D}_{k}^{l}$$

are the horizontal, vertical, and diagonal detail signals at the l^{th} level respectively. W is a wavelet transformation function.

Following this decomposition and using the stored detail signals for each level, a multi-agent coalition algorithm is performed at each level on the approximation signal, as next step 108.

Initially, each pixel has a phase value. Each group of four pixels is compressed into a single pixel with four detail values (horizontal, vertical and diagonal). The detail signals at each level store the horizontal, vertical and diagonal information of each pixel which is required to losslessly decompress them back into their original form after wavelet decomposition.

The approximation maps from the 2D decomposition are compressed representations of the original signals. They retain many of the low-wavenumber attributes of the original phase-maps, but, with contracted dimensions, they reduce the space which must be searched in the computationally expensive process of coalition formation.

The element grouping process is formulated as a multi-agent coalition formation problem where an initial set of homogeneous agents are partitioned into groups (referred to interchangeably as “coalitions” or “segments”). This partitioning is performed under the direction of a multi-objective fitness function which maximises a positive quality term and minimises a negative cost term.

The high wavenumber attributes for each spatial region of the phase-maps 13a-d are present in the detail signals. While the approximation signal helps to identify groupings, the variance in the detail signal helps to identify fixed displacements within elements in a grouping.

If the variance in the detail values (horizontal, vertical and diagonal signals) across the set of images is below a threshold τₖ, this shows there is some fixed difference in phase between the four pixels which will be created following a decompression operation which persists across each pattern in the set. This means that the multi-agent algorithm recommends grouping the four constituent pixels which are created as it expands into the next level of decompression.

The detail signals preserve the constant differences between the four constituent pixels and provide detail on the similarities, and for this reason will allow coalitions to be formed with constant displacements between constituent members when decompression occurs and is below τₖ. Pixels which fail this “detail check” are ejected from any coalition they are a member of and the four constituent pixels, after the decompression operation is performed, will go to the next level as individuals.

The coalitions and details in level k−l are propagated to the next level k, ∀k<j. The approximate signal at k is computed by the inverse wavelet transform using the coalition map as the approximate signal from k−1 and the detail signals, preserved during the original decomposition. These steps are repeated on each subsequent level until the process returns to k=jₘₐₓ, the scale of the original input phase-maps 13a-d. At this level the algorithm will output the coalition structure—the optimised pattern of coalitions which an SSM should be split into, as well as the constant differences between the constituent pixels of those coalitions. Combining these with the set of input phase-maps 13a-d, segmented phase-maps can be constructed.

The hierarchical representation used allows viable coalitions to be searched and found with many agents by splitting the large coalition formation problem involving the full set of agents into multiple coalition formation problems with smaller sub-sets. These smaller sub-sets are expanded, along with the coalitions formed there as the wavelet transform methodology progresses.

The compressed sets of agents correspond to the approximate decomposed phase distributions Aₖ^{l} described above, where each value in these distributions represents a sound modulating agent. Starting from the deepest compression level lₘₐₓ the details signals are used to propagate the coalition structures from one level to another, starting from the original set of agents. At each compression level, the set of agents is split into an approximate set containing fewer agents and three other sets capturing the differences between the agents at the previous level. Starting from the most compressed set of agents, the algorithm solves the segments in problem involving the approximate set of agents and repeat until reaching the level with the original set of agents.

At each decomposition level j, coalitions are formed on pixels (x, y), x, y∈{1, . . . , m} for which the details variance across images is below the threshold τₖ:

$$Var ( {S}_{i}^{j} ( x , y ) , i ∈ \{ 1 , … , {n}_{T} \} ) \leq τ ( j ) , S ∈ \{ H , V , D \}$$

T(j) is the details threshold at level j. For each pixel satisfying the condition above, the details across the images are updated by their average:

$${\tilde{S}}_{i}^{j} ( x , y ) = Mean ( {S}_{i}^{j} ( x , y ) , i ∈ \{ 1 , … , {n}_{T} \} ) , S ∈ \{ H , V , D \}$$

Each of these pixels is expended to a group of 4 pixels in the previous decomposition level j−1. Pixels that do not satisfy the condition will form 4 separate pixels. After forming coalitions, for each coalition Cₖ in the generated coalition structure CS, the approximation value of its constituent pixels is replaced by the average of their values for each image:

$${\tilde{Q}}_{i}^{j} ( {x}_{k} , {y}_{k} ) = Mean ( {Q}_{i}^{j} ( x , y ) , ( {x}_{k} , {y}_{k} ) ∈ {C}_{k} ) , i ∈ \{ 1 , … , {n}_{T} \}$$

After building coalitions and updating the different signals at level j, the approximation and the details at level j−1 are reconstructed using the inverse wavelet transform:

$${\tilde{Q}}_{i}^{j - 1} = {W}^{- 1} = [ \begin{matrix}{\tilde{Q}}_{i}^{j} & {\tilde{H}}_{i}^{j} \\ {\tilde{V}}_{i}^{j} & {\tilde{D}}_{i}^{j}\end{matrix} ]$$

W⁻¹ is the inverse transform operator. This process is repeated until reaching level 0.

Two tuning factors can be incorporated in order to tune the algorithm. The first tuning factor, α, is a coefficient in the cost function which represents the cost of a single actuation. Therefore, for a higher α, a single actuation is more expensive and so the method looks to make larger (and therefore fewer) coalitions. Therefore, α weights the size of the “best coalition” the algorithm picks in each iteration. The second tuning factor, β represents the threshold which the horizontal, vertical and diagonal discrete wavelet details must be under in order for a coalition to transition between levels of compression intact. The threshold τₖ=β/(2×cₗₑᵥₑₗ+1))

FIG. 3C shows the optimised segmented phase maps derived from the target images 9a-9d shown in FIG. 3A.

Using the derived segments, a segmented SSM device 1′ can be manufactured in step 110. The device 1′ is shown in FIG. 3D.

The SSM device 1′ in FIG. 3D designed based on the output of the above algorithm. The sound modulation elements 5 are grouped into a number of segments 15a-p (shown by darker outlines). The elements 5 in each segment 15a-p are all actuated together. Therefore, the device 1′ is able to represent each of the target images 9a-d with a minimised number of actuations required to switch between the different states.

As shown in FIG. 3D, the segments 15a-p are non-homogenous in size and shape. In some cases, segments may be only a single sound modulating element 5, whilst in other cases, the segments 15a-p may comprise a plurality of sound modulating elements. Each element 5 is only in a single segment 15a-p, and so the segments are non-overlapping.

Furthermore, whilst in the example shown, the segments 15a-p may comprise a single contiguous block, in other examples, a segment 15 may comprise sound modulating elements that a spatial separate from each other, or spatially separated cluster of elements 5.

Each segment 15a-p may comprise sound modulating elements 5 that all take the same phase value in each output image 9a-d. In addition or alternatively, segments 15a-p may include sound modulating elements 5 that have different phase value in each output image, but in which the relative differences between the phase is the same in each output image.

As will be discussed below, any suitable control mechanism can be used to actuate the elements 5.

Each element 5 may be arranged to passively apply a phase modulation φ without any actuation. Actuation of the sound modulating element 5 may apply a further phase modulation of δ, such that the total phase modulation is φ+δ. In segments 15 where each sound modulating element 5 has the same phase value, the value of φ is the same for each sound modulating element 5 and then further phase change of δ is applied to each element 5. In segments 15 where there are always relative differences between the phase values, φ may be different for each element 5. The same value of δ is still applied to each element 5.

In the example discussed above, the SSM device 1′ is a square array of 64 sound modulating elements 5. This is by way of example only. The device 1′ may be of any size and any shape. Any number of segments may be formed, depending on the target outputs.

The steps of 106 creating the nested hierarchy and 108 performing a multi-agent coalition algorithm is just one way that sound modulating elements 5 can be grouped together. Other grouping methods for identifying similarities will also be appreciated.

Various examples of SSM devices 1 designed according to the methods described above will now be discussed with reference to FIGS. 5 and 6.

In the discussion of FIGS. 5 and 6, the quality of acoustic images generated by the output of segmented phase-maps is assessed by using the Structural Similarity Index Measure (SSIM), as discussed in Wang, Z., Bovik, A. C., Sheikh, H. R. & Simoncelli, E. P. Image quality assessment: From error visibility to structural similarity.

The SSIM takes into account the structural differences between two images, making it useful for comparing a distorted or degraded image to its original. The SSIM comparison of two images x and y and has three terms corresponding to the three contributing similarity factors; luminosity l, contrast c, and structure s, as shown below:

$$SSIM ( x , y ) = {{{[ l ( x , y ) ]}^{α} [ c ( x , y ) ]}^{β} [ s ( x , y ) ]}^{γ}$$

α, β, and γ are weighting constants which are set to unity for the purpose of simplicity. Luminosity l, contrast c, and structure s are defined as:

$$l ( x , y ) = \frac{2 {μ}_{x} {μ}_{y} + {C}_{1}}{{μ}_{x}^{2} + {μ}_{y}^{2} + {C}_{1}}$$

$$c ( x , y ) = \frac{2 {σ}_{x} {σ}_{y} + {C}_{2}}{{σ}_{x}^{2} + {σ}_{y}^{2} + {C}_{2}}$$

$$s ( x , y ) = \frac{{σ}_{xy} + {C}_{3}}{{σ}_{x} {σ}_{y} + {C}_{3}}$$

μx, μy, σx, σy and σxy are the means, standard deviations and cross-covariance for the two respective images. C1=(K1L)2, C2=(K2L)2 and C3=C2/2, where L is the dynamic range of the images being assessed K1=K2<<<1. These constants are employed to avoid instabilities such as division by zero in some cases. The SSM can now be rewritten as:

$$SSIM ( x , y ) = \frac{( 2 {μ}_{x} {μ}_{y} + {C}_{1} ) ( 2 {σ}_{xy} + {C}_{2} )}{( {μ}_{x}^{2} + {μ}_{y}^{2} + {C}_{1} ) ( {σ}_{x}^{2} + {σ}_{y}^{2} + {C}_{2} )}$$

To further assess the method discussed above, pressure maps are calculated using the ASM method are compared with similar propagations from the segmented output phase-maps. The SSIM is used to compare the relative similarity between the contrast, luminosity and structure of a first pressure map generated based on the segmented phase maps and a second pressure map generated based on the input phase maps 13a-d (i.e. without any segmentation applied). A comparison of this kind returns a normalised quality measurement of 1, where the segmented propagation is maximally similar and identical to that of the input propagation, and 0 where input and output propagations are maximally dissimilar.

In addition to the SSIM the outputs derived from the segmented coalition structures are compared with that of a simple “naïvely” segmented version of the phase maps. The naïve version is formed by taking regularly spaced and shaped groups of pixels and naïvely joining them into segments, propagating the results to give a naïve absolute pressure image. For example, for an input phase-map 13a-d with 32×32 pixels of size λ/2, one way to build a naïve coalition structure would be to simply join each 2×2 square of pixels to create a 16×16 phase-map with λ-sized pixels. In this case, the structure contains 322/4=256 coalitions.

A Pareto front is also plotted for any given set of input phase-maps, constructed through many individual runs of the algorithm, with the tuning factors adjusted slightly in each case. Each of these provide a ratio between coalition structure size and mean image quality across all of the output segmented phase-maps.

FIG. 5A shows an example of a first set 7₁ of target images 9₁a to 9₁d for an SSM device 1 that can be used as a haptic elevator panel. The finite set 7₁ of target images 9₁a-9₁d for such an SSM device 1 would thus be the set of floor numbers to be displayed. The targets are shown as a combination of Latin and Arabic letters and numerals in this case for clarity. However, this could also be encoded into the SSM device 1 as Braille glyphs. The set of unsegmented phase maps input into the method are formulated for an SSM device 1 with an array 3 of 32×32 sound modulating elements.

FIG. 5B shows the Pareto Front sweep for different segmentation options for this SSM device 1, calculated with varying values of the tuning parameters (α and β). The Pareto Front sweep shows the mean of the SSIM values determined for all of the set 7₁ of target images 9₁a-9₁d as a function of the number of separate actuations required (which is inversely proportional to the number of segments in each possible design). Each dot represents a possible segmented design determined by the method discussed above, whilst the crosses represent possible naïve segmented structures. As shown by this plot, the segmentation algorithm is able to segment the structure with about 0.1 higher mean SSIM score than the naïve segmentation.

The inset of FIG. 5B shows a zoomed view of the distribution in which two data points have been highlighted. The highlighted data point represents two structures having the same number of segments (256)—a first (labelled segmented) generated by the methods discussed above and a second (labelled naïve) generated using naïve segmentation. FIG. 5C shows the coalitions formed by the method discussed above and FIG. 5D shows the coalitions formed by the naïve method.

Comparing FIGS. 5C and 5D, it can be seen that the segmented structure is heterogeneous in nature and its coalitions contain pixels with constant differences. In contrast, the naïve structure is homogeneous and its coalitions are simple, flat averaging of their constituents.

FIGS. 5E and 5F show the changes in the changes in the height of a reflective surface from a reference height which are needed to provide each of the configurations in the finite set and produce the acoustic images. FIGS. 5G and 5H show the absolute pressure propagations of the segmented and naïve structures respectively.

The segments determined by the above method provide a closer approximation of the target images 9₁a-9₁d than the naïve segmentation process. The greater-than-wavelength elements of the naïve structure create aliasing effects in the form of low-pressure streaks in some parts of the image.

In a second example, the SSM device 1 may be arranged to operate as a simple acoustic lens device which focuses sound waves a point, at varying focal lengths, in a manner analogous to optical lenses. For example, the lens may vary between a focal length of 50 mm and 100 mm in 10 mm increments.

In this case the input phase maps 13 represent an SSM device 1 having a 16×16 array 3 of sound modulating elements 5. FIG. 6A shows the Pareto front plot for this case. Again, the naïvely formed segments are shown in crosses.

The segmentation algorithm performs especially well in this case due to the low diversity of the input phase maps. FIG. 6B shows a second Pareto plot, obtained by performing an additional post processing step on both the segmented and naïve coalition structures which leverages the symmetry of all input phase maps to reduce the number of actuators required. The inset here again highlights a comparable segmented and naïve coalition structure for comparison.

In this case the segmentation method 200 has output a structure needing only nine actuators which has significantly higher SSIM value than the naïve structure which requires 16 actuators. FIGS. 6C and 6D show the coalition structures for these two segmented and naïve structures respectively, with the different numbers representing distinct coalitions in each case. The symmetry of both structures can clearly be identified here.

FIGS. 6E and 6F show the absolute pressure propagations of the segmented and naïve structures respectively. From these, it can be seen that the naïve method of segmentation is actually incapable of producing the focusing operation. By contrast, the segmented version provides focusing with a 98.6% similarity of image quality to the unsegmented versions and a reduction in the required actuator from 256 to 9.

The examples discussed in FIGS. 5 and 6 show that the coalition structures obtained give improved quality-to-size ratios. It will further be appreciated that by selection of tuning factors and the number of coalitions, a balance can be struck between image quality and reduced number of actuators.

The method 100 discussed above can be used to generate a segmented structure for any type of SSM device 1. Two different examples of SSM device 1 will now be discussed, by way of example only, with reference to FIGS. 7 to 16.

FIG. 7A schematically illustrates a single sound modulating element 500 that can be used in an SSM device 1 such as discussed above. The sound modulating element 500 is arranged to reflect incoming sound wave and modulate the phase of the incoming sound wave as it is reflected.

The sound modulating element is formed on a microfluidic chip 502. A fluid channel 504 is formed in the body 506 of the chip 502. The channel 504 ends in an opening 508 on a front surface 510 of the chip 502. A deformable membrane 512 is provided on the front surface 510 of the chip. Over the opening 508, the membrane 512 is free standing.

A fluid 514 is received in the channel 504, exerting upward pressure on the free standing part of the membrane 512. In one example, the fluid may be water but any suitable fluid may be used. As the fluid pressure or volume in the channel 504 is varied, the free standing part of the membrane 512 is able to inflate and deflate, increasing and decreasing in height above the front surface 510.

A frame 516 or guide is provided on top of the membrane 512. The frame 516 is a hollow cylinder extending around the opening 508 into the channel 504, and in an axial direction 518 perpendicular to the front surface 510 of the chip 502. The free standing part of the membrane 512 is received within the frame 516.

A reflector 520 is slidably received in the frame 518. The reflector 520 comprises a tail portion 522 (or leg) extending along the axial direction 516 within the frame 518, such that a first end 524 of the reflector forms an engaging surface 526 which sits on the free standing portion of the membrane 512.

The tail portion 522 of the reflector 520 extends out of the top of the frame 518 and widens into a head portion 528. The head portion 528 comprises a planar reflecting surface 530 forming a second end 532 of the reflector 520, opposite the engaging surface 526. The reflecting surface 520 extends parallel to the front surface 10 of the chip 502.

As the free standing portion of the membrane 512 inflates and deflates, the reflector 520 is moved along the axial direction 516, changing the distance between the reflecting surface 530 and the front surface 510 of the chip 502. This causes a path length change for sound waves incident on the surface 530, thus changing the phase of the sound wave as the reflector 520 moves.

The head portion 528 of the reflector extends wider than the frame 518, thus setting a minimum distance between the reflecting surface 530 and the front surface 510 of the chip 502, when the head portion 528 rests on the top of the frame 518.

Depending on the size of the head portion 528, multiple tail portions may be provided, each engaging separate unsupported portions of the membrane 512.

The area of the reflecting surface 530 and the size of the range of motion of the reflector is determined by the wavelength of sound waves to be used. Typically, the reflective surface of each pixel has an approximate area of (λ/2)², and the extent of vertical motion is arranged to allow a phase variation between ±π. In one example, the SSM device 1 is for use with ultrasound waves operating at a central frequency of 40 kHz and λ is 8.66 mm.

FIG. 7B schematically illustrates the fluid circuit for controlling the sound modulating element 500. A fluid reservoir 534 (or other source) is connected to the microfluidic chip 502 through a control device 536 such as a pump or valve. The control device 536 is able to remove fluid from the channel 504 or provide fluid into the channel 504 to inflate or deflate the membrane 512, thus forming a control mechanism. After the volume of fluid in the channel is changed to height, the control device 536 closes the channel. Thus the predetermined amount of fluid is held in the channel 504 without ongoing actuation.

The sound modulating element 500 shown in FIG. 7A is for providing a single pixel in an SSM device 1. An SSM device 1 will comprise an array of these sound modulating elements 500.

In one example, each pixel requires a separate channel 504 and a corresponding control device 536. However, as discussed above, the sound modulating elements 500 (pixels) may be grouped into segments or coalitions.

Where the SSM device 1 includes segments 1 or coalitions, a single reflect 520 may provide the reflecting surface corresponding to one or more different sound modulating elements 500 (pixels).

FIG. 8A shows a further example of segments 15 formed in a 16×16 array 3 of sound modulating elements 500. The segments 15 are formed using the methods discussed above. Each segment is numbered, with 11 segments in total. The example shown in FIG. 8A is the segments used for forming an acoustic lens.

Even without any actuation, the SSM device 1 does not have a flat profile. Each element 500 is designed with a default height. Therefore, each segment 15 would generally contain segments of varying heights, forming a gradient.

FIG. 8B shows a reflector 520a which is part of segment number 8. The head portion 528a has four separate reflecting surfaces 530a1-4, each with a different height but all extending parallel. This segment is equivalent to four pixels.

The reflector 520a still comprises a single tail portion 522a extending into the frame. In this example, the opening 508 in the front face 510 of the microfluidic chip 502 may be the size of four elements. The tail portion 522a and frame 518 may be accordingly sized. For this reflector, only one actuator (control device) is required rather than four.

Overall, segment number 8 is made of four of the reflectors 520a shown in FIG. 8B. Each may be connected to a separate channel 504 in the chip 502 with a dedicated control device 536. Alternatively, two or more of the reflectors 520a may be connected to a single channel 504 and control device 536, or to separate channels, each connected to the fluid reservoir 534 through a single control device 536.

FIG. 8C shows the reflector 520b for forming segment number 11. This covers an area of 64 pixels. In a similar manner to the 4 pixel reflector 520a, the reflector 520b of FIG. 8C includes 64 separate reflecting surface 530b, some arranged at the same height to each other and others at different heights.

In this case, the segment is designed with four tail sections 522a. this therefore requires four openings 508 to be formed in the microfluidic chip 520. As with the separate reflectors 520a for segment 8, each opening which corresponds to an actuator and may be connected to a separate channel 504 in the chip 502 with a dedicated control device 536. Alternatively, two or more of the tail sections 522b may be moved by inflation or deflation of the membrane at openings 508 connected to a single channel 504 and control device 536, or to separate channels, each connected to the fluid reservoir 534 through a single control device 536.

It will be appreciated that a reflector 530 could have any number of tail sections 522.

It will also be appreciated that the frame 518 can be arranged for the different size segments 15. In one example, the frame 518 may simply provide borders around the edges of each segment 15. However, in other examples, the frames may provide separate borders or guides borders for each tail section 522. FIG. 8D shows an example of the frame 518 for the SSM device 1 discussed with reference to FIGS. 8A to 8C. in this example, the frame 518 provides borders around each reflector 520.

FIG. 9 illustrates a flow diagram of a process for manufacturing an SSM device 1 including the fluidly actuated sound modulating elements 500 discussed above.

In a first step 602, the microfluidic chip 502 is manufactured. The microfluidic chip 502 includes one or more inlets 538 for coupling to a fluid source 534 and control device 536 and one or more openings 508 for coupling to reflectors 520.

In some examples, the chip 502 may be formed of a plurality of layers 542 to form the desired shape of the channels 504. This is because when a single reflector 520 is actuated by multiple openings 508 which are connected together, the pressure at the openings 508 must be distributed equally to avoid uneven vertical actuation. The channels 504 are designed in such a way that each openings 508 within a common segment are the same distance from the corresponding inlet 538 as each other.

By way of illustrative example, FIG. 10A shows a schematic view of a microfluidic chip 502 in top down view. The microfluidic chip 502 has nine openings 508a-i in the front surface 510 in a regular 3×3 array and three inlets 538a-c. The openings 508a-i are arranged into three segments 540a-c as indicated by the dot-dashed lines. The channels 504a-c extending underneath the front surface 510 are shown by even dashed lines.

FIG. 10B shows the microfluidic chip of FIG. 5A in exploded perspective view, showing the separate layers 542a-e.

A topmost layer 542a forms the front face 510 and includes the outlet openings 508a-i. This layer also includes a rim 544 for locating the membrane 512 and frame 518.

The second layer 542b is a first interconnect layer. This includes first through-passages 546 connecting the openings 508a-i in the top layer 542a to portions of the channels 504 in the layer below 542c.

In order to allow equal pressures to be applied at each outlet 508a-i, each segment 540a-c can be split into sub-segments, with the openings 508a-c in each sub-segment connected by a channel portion. Each subsegment is supplied with pressure at a centralised point.

The third layer 542c forms first portions of the channels 504a. These are formed as slots 548 extending through the layer 542c. The slots 548 are closed to form channels by the layers 542b, 542d on either side of the layer 542c including the slots 548. Where the slots 548 line up with through passages 546, 550 in the layers 542b, 542d on either side, fluid can move between layers 542. The slots 548 begin and end at positions located centrally with respect to the openings 508a-i.

In the case of segments 540a split into sub-segments, the channel portions connect the openings 508a,b,d,g in a sub-segment to a central point that is equidistant from each opening 508a,b,d,g. In the case of segments 540b which are not split into sub-segments, the channels portions connect the openings 508c,e,f,h,i in a segment to a central point that is equidistant from each opening 508c,e,f,h,i.

In some cases, the central point may be located on a line between openings 508a-i. In these cases, the channel portions may simply extend between openings 508a-i. In other cases, the central point may be formed off the grid defined by the openings 508a-i. Where slots from more than two openings 508a-i meet at a central point, the slot may be widened and/or shaped to provide equal pressure distribution.

In the example shown:
The “L” shaped segment 540a is split into two sub-segments with a first channel portion extending between a first opening 508a and a second opening 508b forming the first sub-segment, and a second channel extends between a third opening 508d and a fourth opening 508g forming the second sub-segment.
A second segment 540b has two openings 508c,f and so the channel portion extends between the openings.
A third segment 540c has three openings 508e,h,i. Channel portions from each openings 508e,h,i to a wider opening at central point.

The fourth layer 542d is a second interconnect layer. This is a number of second through passages 550 extending at the central points of the channel portions in the third layer 542c.

The final layer 542e is a base layer. This has channels formed as grooves 552 extending from the inlets to the through passages in the second interconnect layer 542d.

The base layer 542e also include side walls 556 to locate the second, third and fourth layers 542b-d.

The scheme suggested above can be scaled to any number of layers 542a-e and openings 508a-i. In general, the microfluidic chip 502 has a layered structure comprising a base layer 502e, a top layer 502a, and between the base layer and top layer alternating interconnect layers and channel portion layers.

In the above example, the segments are only split into sub-segments once. However, by adding further layers, complex structures can be broken into tiered sub-segments, such that the number of passages between each layer increases from the bottom up.

Where openings or channel portions all correspond to the same cluster of pixels, the openings or channels may be grouped in each layer 542, so that fluid pressure may be symmetrically delivered between layers. Each channel portion receives fluid pressure from an upstream layer at a central position, and provides fluid pressure to a downstream position at the ends of channel portions.

Any suitable method may be used for making the microfluidic chip 502. The layers may be formed separately and joined together by adhesive and/or mechanical fixing, or the layers may be formed as a single unitary part. If necessary, seals may be provided between layers.

In one example, traditional soft lithography process may be used to make the chip. In other examples, the layered microfluidic chip 502 is three-dimensionally (3D) printed as a single monolith using tabletop LCD-based Digital Light Processing. (DLP, Phrozen Sonic Mini 4K). The DLP prints may use Siraya Tech Fast Smoky Black resin and do not require any support material.

Various post processing steps may be completed after the chip 502 is printed. For example the chips may be washed and UV-cured (405 nm LED) in an AnyCubic Wash & Cure Machine 2.0.

Returning to the process of FIG. 9, the second step 604 is formation of the membrane 512. The formation 700 of the membrane 512 is discussed with reference to FIG. 11.

As shown in steps (i) and (ii) shown in FIG. 11, two glass plates 702 are coated with standard dishwashing liquid soap 704. The soap was diluted with de-ionised water (approximately ¾) and evenly sprayed over the plates. Thereafter, the soap was left to air-dry overnight. The purpose of this coating is to ensure that the membrane 512 does not stick to the glass plates 702 after curing, which makes removal significantly easier.

The next step (iii) involves placing spacer films 706 on one side of a first glass plate 702a. The spacer films 706 determine the thickness of the membrane. In this example, the spacer film is polyethylene terephthalate (PET) films with a thickness of 100 μm.

In step (iv), the material for forming the membrane, for example silicone 708, is dispensed at the centre of the plate 702a. The silicone 708 is not allowed to spread too close to the spacer film 706. This is to prevent the silicone from seeping beneath the film and compromising the thickness.

In the final step (v), the second glass plate 702b is aligned and placed over the first glass plate 702a with the silicone 708 and spacer film 706. The two plates are sandwiched together tightly with the use of two binder clips (not shown) on each of the four edges, and the silicone is left to cure overnight. The resulting membrane 512 had a thickness of approximately 100 μm.

The membrane 512 is made from any flexible and waterproof material which does not easily tear. In one example, the membrane may be Ecoflex™ 00-30, which can be cured into a highly stretchable silicone thin film. Ecoflex™ is a two part polymer. Prior to dispensing in step (iv) of FIG. 11, the Ecoflex™ the constituent parts of Ecoflex™ are mixed in a 1:1 ratio and vacuum desiccated for 2-3 min to remove bubbles. If the bubbles are not removed, the cured membrane may have micro-holes and tear easily.

After formation of the membrane 512, it is removed from the glass slides 702a, 702b, and fixed to the microfluidic chip in step 606.

The membrane 512 can be adhered to the surface of the printed microfluidic chip 512 using any suitable fixing means. In one example, waterproof room-temperature vulcanising (RTV) silicone sealant (Tian Mu, TM-704) may be used. TM-704 has a shear strength of 8 mPa, and a comparable shore hardness to Ecoflex™ 00-30, at 35 A.

As best shown in FIG. 10B, a lip 554 is formed around the openings 508 to prevent the RTV (or other sealant) flowing into the openings 508.

After the membrane 512 is fixed using RTV, it is cured at room temperature for 24 hours to reduce delamination of the membrane 512. The membrane 512 thus seals the front surface 510 of the chip 502, and prevents any leakage when the device 1 is tilted.

It will be appreciated that a single membrane 512 may cover a plurality of openings 508, with each unsupported portion of the membrane 512 acting independently. Alternatively, a number of different membranes 512 may be provided. In some cases, a single membrane 512 may cover all openings 508 in the chip 502 and in others, separate membranes 512 may cover one or more openings 508 each.

FIG. 12 shows an example of a microfluidic chip 502 with a single inlet 538 and a single outlet 508, with a diameter of 3 mm. The chip has a thickness of 5 mm. The images show the increasing size of the membrane as the amount of water in the channel is increased by 0.01 ml increments. The bubble labelled a) has a height of ˜1.5 mm for 0.1 ml of water. The bubble labelled b) has a height of ˜4 mm, with 0.05 ml and the bubble labelled c) has a height of ˜6 mm for 0.1 ml of water. The dashed line is used as an aid to visualise that the bubble is increasing in height.

Even though the diameter of the outlet hole is 3 mm, the bubble in the membrane 512 may be inflated to heights >3 mm, and even up to double the outlet diameter at 6 mm without bursting.

In a fourth step 608, the frame 518 and reflectors 520 are made. These can be made by any suitable method that provides low friction sliding between the frame 518 and reflectors 520.

In one example, the frame 518 and reflectors 520 are 3D-printed on a Stratasys J750 multi-material Polyjet in the transparent VeroClear™ material. As the reflecting surface 530 overhangs the frame, the structures were printed with water-soluble support material (for example SUP705). However, the frames 518 and reflectors 520 can also be printed with DLP without support material, and processed to form the overhang.

In a final step 610, the frame 518 is secured to the chip 502. Any suitable method can be used to secure the frame 518. For example, the frame 518 may be secured by a friction fit with raised edges on the perimeter of the chip 502, by using clips, by using adhesive, or any other suitable method.

In one example, all the layers 542a-e with parts of the channels or through holes may have the same thickness (e.g. 1 mm), but any of these layers 542a-e could be increased or decrease in thickness if necessary.

In the example discussed above, the inlet to the channel 504 is in the bottom most layer, and then fluid only flows up the layers. However, the inlet may be provided in any layer 542a-e, and the fluid may flow down and up the layers (with lateral movement in between,

In the examples discussed above, simple geometric base shapes like rectangles or triangles or used for the channels 504. If required, future designs can include more complicated shapes such as serpentine or spiral channels 504.

In the examples discussed above, the channels are all of the same size (1 mm high and wide), the outlet openings 508 are all of the same size, and all outlet openings are equidistant from any branch point in the channel 504. This ensures equal fluid pressure at all fluid openings 508.

However, equal pressures may be achieved in any suitable way. For example, channels may be narrowed or widened in correspondence to changing size of outlet openings and/or distances form branch points to ensure the unsupported portion of the membrane inflates by equal heights at each opening 508. Alternatively, the reflectors may be arranged to accommodate different heights of inflation at different openings.

In the examples discussed above the microfluidic chip 502 is used to make a segmented SSM device 1. However, this need not be the case, and each element 500 (pixel) may be actuated independently.

The structure of the reflector 520 and frame 518 are examples only, the frame 518 may have any shape that can guide the axial movement of the reflector 520, and the reflector can have any shape that provides a planar reflecting surface. In some examples, the reflectors 520 may move unguided.

FIGS. 13A and 13B schematically illustrates a second embodiment of a single sound modulating element 800 that can be used in an SSM device 1. The element 800 is shown in cross-section side view. In this embodiment, the sound modulating element 800 is arranged to transmit incoming sound wave and modulate the phase of the incoming sound wave as it is transmitted.

The element 800 comprises a wall 802 defining a channel 804 extending from an opening 806 at a first end 808 to an opening 810 at a second end 812. The wall 802 is made from rigid material, such as a rigid printable plastic.

In cross-section perpendicular to a direction between the first end 808 and second end 812, the channel may be any shape, such as circular, square, or other shapes. It will be appreciated that certain shapes (such as square or hexagonal) allow for arrays of elements 800 to be easily created.

A pair of flaps 814, 816 extend into the channel 804 from opposing sides. Each flap 814, 816 is secured to the wall 802 of the channel 804 at a respective first end 818, 822 and is free at a respective second end 820, 824.

In the direction between the first end 818, 824 and second end 820, 826, the length of the flaps 814, 816 is a proportion of the width of the channel 804. Parallel to the first and second ends 818, 820, 822, 824, the flaps 814, 816 extend the full width of the channel 804. The thickness of the flaps 814, 816 is significantly less than the length of the channel 804.

The first flap 814 is located at a point between the first end 808 and second end 812. This is a dynamic flap that rotates about the end 818 of the flap 814 fixed to the wall of the channel 804. In one example, the dynamic flap 814 can rotate to any angle between a position perpendicular to the length of the channel 804 (FIG. 13A) and a position substantially parallel to the length of the channel (FIG. 13B).

In one example, the dynamic flap 814 may be made of a resiliently deformable material (such as an elastomeric rubber) including a magnetic nanocomposite material. This eliminates the need for hinge like arrangements, and allows the dynamic flap to move reversibly without the need for reset signals.

A magnetic field generator or electromagnet 826 is provided outside the channel 804. Variation of the magnetic field applied by the field generator 826 causes rotation of the dynamic flap.

The second flap 816 is a rigid flap located at a point between the dynamic flap 814 and the second send 812. The rigid flap 816 is integral with the wall 802 defining the channel 804.

Sound is incident on the first end 806 of the channel. The flap 814, 816 create a labyrinthine path that the sound must pass through. As can be seen by comparison of FIGS. 13A and 13B, rotation of the dynamic flap varies the length of the labyrinthine path, thus varying the phase of the sound wave as it exits the second end 810 by changing the time of flight of wound waves as they pass along the channel 804. The magnetic field generator or electromagnet 826 can thus be considered a control mechanism for controlling the sound modulating element 800.

The cross-sectional size of the channel 804 is sub-wavelength of the sound waves it is intended for use with. For example, when the element is for use in the ultrasonic regime (>20 kHz), the channel 804 may have a square cross section of 5 mm width. The channel 804 may have any length which provides the desired path length. In one example, the length of the channel may be a single wavelength of the sound waves it is intended for use with, but this is by way of example only.

It will be appreciated that by including the rigid flap 816, each channel passively applies a modulation of φ (compared to the straight through path length). The angle of the dynamic flap then applied a variable phase modulation of δ by dynamically varying the path length.

A permanent magnetic field may be applied to tune the position of the dynamic flap to a default position (generally one of the positions shown in FIG. 13A or 13B). The field is then varied by the field generator 826 to vary the position of the dynamic flap 814.

The element 800 shown in FIGS. 13A and 13B can easily be scaled into an array 3 of elements. For example, an array of channels 804 with static flaps 816 of equal length can be fabricated as a single unitary part or as multiple parts joined together. As will be discussed below, dynamic flaps 814 can then be provided in some or all of the channels 804.

In order to control movement of the dynamic flaps 814, magnetic field generators 826 are arranged around the outside of the array 3. In some examples, shaped fields can be used to control flaps away from the edges of the array 3. Furthermore, the relative proportion of the magnetic nanomaterial in the flaps may be varied to vary the response of dynamic flaps to different fields. Alternatively, dynamic flaps 814 may only be provided in channels 804 at or near the edge of the array 3

As discussed above, individual sound modulating elements 800 can be grouped into segments that are actuated together. Therefore, a single magnetic field generator 826 can be used to control the movement of dynamic flaps 814 in a number of channels forming a segment. The length of the static flap 816 can be different for different channels to allow channels in the same segment to apply different modulations, which have a constant different in all target images.

FIG. 14 illustrates a method 900 of making an SSM device 1 using sound modulating elements 800 as discussed above.

In a first step 902, the passive and rigid components (the channel walls 802 and rigid flap 816) are made using 3D printing or any other suitable manufacturing process. In one example, the wall 802 of the channel(s) 804, including the internal static flap 816 may be 3D-printed on Stratasys J750 multi-material Polyjet using transparent VeroClear™ material. The print may include a water-soluble support material (SUP705), which is removed by being submerged in water. The printed channels 804 are air-dried and blow-dried with nitrogen.

In a second step 904, the dynamic flap 814 is fabricated using a moulding and casting method. FIG. 15 illustrates one example of the process 904 for making the dynamic flap 814. The flap 814 is made outside the channel 804, and then secured in the channel 804 at a third step 906.

Prior to making the flap 814, the material of the flap 814 is prepared. The polymer used for the flap is mixed with a nanoparticle material and then vacuum desiccated to remove bubbles. If the bubbles are not removed, the cured flap 814 may have micro-holes and tear easily.

In the example being discussed, the flap is made of Ecoflex™ 00-30. As discussed above, this can be cured into a highly stretchable silicone thin film. In a similar manner to making the membrane 812 in FIG. 11, the constituent parts of Ecoflex™ are mixed in a 1:1 ratio. Magnetic nanoparticles, such as Fe₃O₄, having a diameter of ˜0.30 μm are combined with the Ecoflex™ in a ratio of 3:1 (Ecoflex™: nanoparticles) and hand mixed for 90 seconds. The magnetic mixture is then vacuum desiccated for 2-3 min to remove bubbles.

In a first step (i) of FIG. 15, the magnetic mixture is dispensed into a mould 828 with a recess 828a formed in its upper face 834.

The mould 828 may be made by any process. In one example, the mould 828 is 3D-printed using LCD-based DLP, on a Phrozen Sonic Mini 4K, using Siraya Tech Fast White resin. The print is washed and UV-cured (405 nm LED).

In a second step (ii) of FIG. 15, one or more glass plate 830 are brought in contact with the surface 834 of the filled mould 828. Binder clips (not shown) are used to apply pressure by sandwiching the mould 828 and glass plate(s) 830 together, as shown in step (iii). At the same time, the direction of magnetic actuation for the flap 814 is predetermined, through magnetic alignment of the nanoparticles during curing. This can be achieved by curing the flap 814 overnight in the presence of an external magnetic field provided by a magnet 836 (such as a large neodymium (NdFeB) magnet with a magnetic flux density of ˜200 mT and dimensions of 58 mm×10 mm×5 mm).

The cured flap 814 is then removed from the glass plate 832. In some cases, there may be instances of excess silicone which has spread out on the sides of the mould due to overflows during the dispensing process. These portions can be easily cut away by a craft knife or scalpel.

In a fourth step (iv), the flap 814 is secured to a PET film 838 of 120 μm thickness that is sized to be received in the channel 804 of the sound modulating element 800. This can be done using any suitable adhesive, such as fast-drying super-glue.

The PET film 838 with the flap 814 was then glued to the internal wall 802 of the channel 804 using a suitable adhesive 840. The PET film 838 conforms to the surface, without compromising the thickness of the wall 802.

This method of assembly is advantageous because it allows accurate placement of the flap 814 with tight tolerances and does not the need the part forming the channel(s) 804 to be made as multiple components that are later joined together. Instead the part forming the channel(s) 804 can be made as a single unitary piece.

For increased production volume, the pieces of film could be laser-cut with slits to mark the positions of the flaps.

It will be appreciated that in some examples, the glass plate 830 used to apply pressure to the flap 814 may be coated with soap to make a non-stick surface, but this is optional and may be omitted.

In the example shown, the dynamic flap 814 ideally extends perpendicular to the PET film 838 (and hence across the channel 804) in the absence of any magnetic field. It may be that, as discussed, some tuning with a permanent magnetic field is required in order to set this accurately, although in operation this may be considered as a magnetic flux density of 0. In the present of a threshold magnetic field (for example of flux density of ˜150 mT) the flap 814 moves toward the PET film 838 and lies substantially parallel to the film 838. For fields having flux density between 0 and the threshold, the angle of the flap 814 is set between 0° and 90°. When the field is removed, it returns to the default position (perpendicular to the film 838).

It will be appreciated that the default position is by way of example only. By controlling the field used during the curing process (step (iii) in FIG. 15), the default position can be changed.

In the example discussed above, the first flap is a dynamic flap 814 and the second flap a rigid flap 816. It will be appreciated that in alternative examples, the first flap may be rigid and the second dynamic.

FIG. 16 illustrates a simulation of an SSM device 1 including a 3×1 array of sound modulating elements arranged from left to right.

In the simulated array, each sound modulating element has an external width of 4.730 mm and an external depth of 4.898 mm (the internal width and depth being 3.730 mm and 3.898 mm respectively. The length of the channel 804 is 8.661 mm (=λ).

The central element (referred to as “B”) has only a static flap 816, applying a fixed phase modulation. The outer elements (referred to as “A”) include a static flap 816 and a dynamic flap 814. State A1 refers to the dynamic flap 814 being parallel to the length of the channel 804, and state A0 refers to the dynamic flap 814 being perpendicular to the channel 804.

The rigid flap 816 extends 1.68 mm across the channel and is positioned 4.3 mm from the first end 806 of the channel 804. The dynamic flap 814 has a length of 2.6 mm and is positioned 2.6 mm from the first end 806 of the channel 804.

The source of sound waves is placed at a distance of λ from the first end 806 of the channel 804.

The first column of FIG. 16 shows the calculated complex pressure measured around the array. The second column of FIG. 16 shows the calculated phase. The position of the array 842 sound modulating elements is shown at the origin.

The third column of FIG. 16 shows the state of the sound modulating elements. This is of the form [X,Y,Z] where X and Z are the states of the dynamic sound modulating elements and Y is the central element. The first row shows the state [A1,B,A0], the second row shows state [A0,B,A1], and the third row shows state [A1,B,A1].

As can be seen, the effect of the sound modulating elements 800 is to steer the sound waves. Therefore, even at this level of complexity, sound modulating elements of this form can be used to steer outputs of more complex SSM devices 1. Larger arrays may be used in the same manner as the SSM devices 1 discussed above.

The simulations were carried out in the commercial software COMSOL Multiphysics®, Version 5.4. Under the Acoustics Module, two-dimensional frequency-domain acoustic pressure models were used based on the Finite Element Method (FEM), which is effective for small, closed-air domains. The piston model formula was applied to model the acoustic pressure input from a physical ultrasonic transducer for an operating frequency of 40 kHz. The speed of sound was set to 346.4 m/s (dry air, 25° C.). To model the high impedance contrast between different materials, i.e. air, plastic, silicone, internal hard boundary conditions were applied to the walls and flap surfaces. External hard boundary conditions were applied on all the external walls. Perfectly matched layers (PML) were placed at the outer edges, which act as absorptive non-reflective boundaries. A series of parameter sweeps were executed to optimise the geometry of the meta-bricks. This iterative approach was primarily employed in favour of speed and efficiency, because it allowed us to quickly narrow down the range of dimensions to construct the bricks. The restrictions enforced by the meta-brick geometry defined the range of parameter values, which were controlled using the COMSOL Multiphysics® in-built ‘parametric sweep’ functionality.

In the examples discussed above, magnetic field generators 826 are placed around the outside of an array 3 of channels 804 forming sound modulating elements 800. However, this is by way of example only. And magnetic field generators may also be provided within the array 3 of channels 804.

The dynamic flap 814 may be switched between two binary states (A0 and A1). Alternatively, by suitable variation of the magnetic fields applied, the angle of the dynamic flap 814 may be varied in steps or continuously over a range.

In the examples discussed above, a static flap 816 is also provided. This may be omitted. Furthermore, in alternative examples, two or more dynamic flaps 816 may be provided to tune the path length along the channel.

The method for manufacturing the SSM device 1 discussed above is given by way of example only. Any suitable method may be used to make the device 1. The rigid flap 816 may be integral with or separate to the wall 802 of the channel 804. Likewise, the dynamic flap 814 may be made in a separate component that is slid into the channel 804 or may be made inside the channel.

In the example discussed above, the dynamic flap 814 pivots around one end 818. However, this is by way of example only, and the dynamic flap 814 may coil and uncoil, shrink or change the labyrinth path in any way. Furthermore, the person skilled in the art will appreciate that other types of pivoting connection are also known.

In all the examples discussed above, SSM devices 1 are considered. SSM devices 1 can be used to generate haptic effects, and to create other acoustic holograms and effects. Furthermore, effects such as acoustic levitation can be used to provide a visible output from a device. It will also be appreciated that the methods discussed in relation to FIGS. 1 to 6 can be applied to any type of display that is to be segmented. For example, the algorithm may be applied to a visual display having light sources arranged to emit light. The algorithm may be used to group light sources or light attenuating elements. Due to the simpler interference effects between light output, the phase maps in this case may simply be directly derived from the target images. Otherwise the method is as discussed above.

1. (canceled)

2. (canceled)

3. (canceled)

4. (canceled)

5. (canceled)

6. (canceled)

7. (canceled)

8. (canceled)

9. (canceled)

10. (canceled)

11. (canceled)

12. (canceled)

13. (canceled)

14. (canceled)

15. (canceled)

16. (canceled)

17. (canceled)

18. (canceled)

19. (canceled)

20. An acoustic device comprising one or more acoustic elements arranged to reflect sound and modulate the sound as it is reflected, each acoustic element comprising:
a fluid channel having an open end;
a membrane extending over the open end of the fluid channel; and
a reflector comprising a reflecting surface and an opposing engagement surface engaging the membrane,
wherein changing a pressure or volume of fluid in the fluid channel inflates or deflates the membrane and moves the reflecting surface, varying the modulation of sound applied by the element.

21. An acoustic device as claimed in claim 20, wherein in each acoustic element:
the open end of the fluid channel is formed as an aperture in a planar surface;
the reflecting surface of the reflector extends parallel to the planar surface; and
moving the reflection surface varies the distance between the planar surface and the reflection surface, keeping the reflecting surface parallel to the planar surface.

22. An acoustic device as claimed in claim 20, each acoustic element comprising a guide member, the reflector slidably engaging the guide member to constrain movement of the reflector along an axial direction.

23. An acoustic device as claimed in claim 20, comprising:
a microfluidic chip;
a plurality of acoustic elements, the fluid channels of the acoustic elements formed in the microfluidic chip, the plurality of acoustic elements arranged into a plurality of non-overlapping groups; and
for each group, a supply channel formed in the microfluidic chip, the supply channel coupled to the fluid channels of the acoustic elements in the group such that the reflecting surface of the acoustic elements in the group move together as pressure or volume of fluid in the supply channel changes.

24. The method of claim 41, further comprising:
making a microfluidic chip defining a plurality of fluid channels having outlet openings in a front face of the microfluidic chip, each outlet opening corresponding to a reflective acoustic element;
securing the membrane to the front face of the microfluidic chip to seal the outlet openings; and
securing a frame on top of the membrane, the frame lining up a reflector forming the reflective acoustic element with an outlet opening in the front face of the microfluidic chip.

25. (canceled)

26. (canceled)

27. (canceled)

28. (canceled)

29. (canceled)

30. (canceled)

31. (canceled)

32. (canceled)

33. The method of claim 24, wherein manufacturing microfluidic chip comprises:
providing a plurality of layers; and
forming the supply channels extending through the layers.

34. A microfluidic chip made comprising a plurality of channels extending between one or more inlets and one or more outlets, such that each inlet may be coupled to one or more outlets, and each outlet is connected to one inlet only, the microfluidic chip comprising multiple layers through which the channels extend.

35. (canceled)

36. The microfluidic chip of claim 34, wherein the chip comprises:
channel portion layers incorporating laterally extending portions of the channels; and
interconnecting layers defining straight through passages between channel portion layers.

37. The microfluidic chip of claim 36, wherein the through passage of an interconnecting layer is positioned at an end point of channel portions in a channel portion layer from which fluid flows into the interconnecting layer.

38. The microfluidic chip of claim 36, wherein the through passage of an interconnecting layer is positioned at a central point of channel portions in a channel portion layer to which fluid flows into from the interconnecting layer, the central point equidistant to the end points of the channel portions in the channel portion layer to which fluid flows into.

39. The microfluidic chip of claim 36, wherein:
outlets in the front face of the microfluidic chip are arranged to form sound modulating elements, the sound modulating elements arranged in groups or segments; and
the groups or segments of sound modulating elements comprise elements that are spatially separate from each other, or spatially separated groups of elements; and
the groups are non-homogenous in size and shape.

40. The microfluidic chip of claim 39, wherein:
the outlets corresponding to sound modulating elements in a segment or group, are organised into sub-segments;
first channel portions in a first channel portion layer directly below the front face may connect openings in a sub-segment;
the first channel portions in the first channel portion layer are organised into one or more groups; and
second channel portions in a second channel portion layer connect the first channel portions, the second channel portion layer being the next channel portion layer in the direction of fluid flow.

41. A method of manufacturing an acoustic device including one or more reflective acoustic elements, each moveable by a membrane as the membrane inflates or deflates to vary sound modulation applied by the acoustic elements, the method comprising:
forming the membrane on a non-stick surface;
applying pressure to the membrane; and
removing the membrane from the non-stick surface for application to the acoustic device.

42. The method of claim 41, wherein pressure is applied by pressing down on the membrane with a second non-stick surface.

43. The method of claim 42, wherein the non-stick surface is a planar area coated with soap.

44. The method of claim 42 comprising providing a spacer between the non-stick surfaces to control the thickness of the membrane.

45. (canceled)

46. The acoustic device of claim 20, having a plurality of acoustic elements, each having a fluid channel having an open end, wherein the same membrane extends over the open end of the fluid channels to form the plurality of acoustic elements.

47. The acoustic device of claim 23, wherein each of the plurality of acoustic elements has a fluid channel has an open end, and the same membrane extends over the open end of the fluid channels to form the plurality of acoustic elements.

48. The acoustic device of claim 47, wherein each acoustic element comprises an unsupported region of the membrane, where the membrane extends over the open end of the fluid channel.

49. The method of claim 24, wherein membrane extends over the outlet opening of a plurality of fluid channels to form a plurality of acoustic elements.
